(19) United States
(12) Patent Application Publication
(10) Pub. No.: US 2023/0088283 A1
(43) Pub. Date: Mar. 23, 2023

(54) METHOD AND APPARATUS FOR TRANSMITTING OVERLAPPING DOWNLINK AND UPLINK CHANNELS IN WIRELESS COMMUNICATION SYSTEM

(71) Applicant: Samsung Electronics Co., Ltd., Gyeonggi-do (KR)

(72) Inventors: Kyunggyu LEE, Gyeonggi-do (KR); Younsun KIM, Gyeonggi-do (KR); Ameha Tsegaye ABEBE, Gyeonggi-do (KR); Youngrok JANG, Gyeonggi-do (KR); Hyoungju JI, Gyeonggi-do (KR); Heedon GHA, Gyeonggi-do (KR); Taehan BAE, Gyeonggi-do (KR)

(21) Appl. No.: 17/902,036

(22) Filed: Sep. 2, 2022

(30) Foreign Application Priority Data
Sep. 3, 2021 (KR) 10-2021-0117844

(51) Int. Cl. H04W 56/00; H04W 72/12; H04L 5/14

(52) U.S. Cl. CPC H04W 56/001; H04W 72/1268; H04W 72/1289; H04W 72/1242; H04L 5/14

(57) ABSTRACT

The disclosure provides a user equipment (UE) and method thereof. The method including identifying a position of a first symbol in which a synchronization signal block is transmitted through cell specific configuration information based on at least one of system information block (SIB) information or higher layer signaling; determining whether a second symbol of an uplink channel configured based on at least one of the higher layer signaling or downlink control information overlaps with the first symbol in which the synchronization signal block is transmitted; transmitting the synchronization signal block without transmitting the uplink channel in response to the determination that the second symbol of the uplink channel does not overlap with the first symbol in which the synchronization signal block is transmitted; and determining whether to transmit the uplink channel according to a predetermined condition in response to the determination that the second symbol of the uplink channel overlaps with the first symbol in which the synchronization signal block is transmitted.

### CROSS-REFERENCE TO RELATED APPLICATIONS

This application is based on and claims priority under 35 U.S.C. § 119 to Korean Patent Application No. 10-2021-0117844, filed on Sep. 3, 2021, in the Korean Intellectual Property Office, the disclosure of which is incorporated by reference herein in its entirety.

### BACKGROUND

### 1. Field

The disclosure relates generally to a wireless communication system, and to a method and apparatus for transmitting overlapping downlink and uplink channels in a wireless communication system.

### 2. Description of Related Art

To meet the demand for wireless data traffic having increased since deployment of fourth generation (4G) communication systems, efforts have been made to develop an improved fifth generation (5G) or pre-5G communication system. Therefore, the 5G or pre-5G communication system is also called a “beyond 4G network” communication system or a “post long term evolution (LTE)” system. The 5G communication system is considered to be implemented in ultrahigh frequency (mmWave) bands (e.g., 60 GHz bands) so as to accomplish higher data rates. To decrease propagation loss of the radio waves and increase the transmission distance in the ultrahigh frequency bands, beamforming, massive multiple-input multiple-output (MIMO) techniques, full dimensional MIMO (FD-MIMO) techniques, array antenna techniques, analog beam forming techniques, and large scale antenna techniques are discussed in 5G communication systems. In addition, in 5G communication systems, development for system network improvement is under way based on advanced small cells, cloud radio access networks (RANs), ultra-dense networks, device-to-device (D2D) communication techniques, wireless backhaul techniques, moving network techniques, cooperative communication techniques, coordinated multi-points (CoMPs) techniques, and reception-end interference cancellation techniques. In the 5G system, hybrid frequency shift keying (FSK) and quadrature amplitude modulation (QAM) (FOAM) and sliding window superposition coding (SWSC) as an advanced coding modulation (ACM), filter bank multi carrier (FBMC), non-orthogonal multiple access (NOMA), and sparse code multiple access (SOMA) as an advanced access technology have also been developed.

The Internet, which is a human centered connectivity network where humans generate and consume information, is evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure technology”, “service interface technology”, and “security technology” have been demanded for IoT implementation, a sensor network, a machine-to-machine (M2M) communication, and a machine type communication (MTC), have been recently researched. Such an IoT environment may provide intelligent Internet technology services that create a new value to human life by collecting and analyzing data generated among connected things. IoT may be applied to a variety of fields including smart home fields, smart building fields, smart city fields, smart car or connected car fields , smart grid fields, health care fields, smart appliance fields, and advanced medical services fields through convergence and combination between existing information technology (IT) and various industrial applications.

Various attempts have been made to apply 5G communication systems to IoT networks. For example, technologies such as a sensor network technology, an MTC technology, and an M2M communication technology may be implemented by beamforming, MIMO, and array antennas. Application of a cloud RAN as the above-described big data processing technology may also be considered an example of convergence of the 5G technology with the IoT technology.

### SUMMARY

The present disclosure has been made to address the above-mentioned problems and disadvantages, and to provide at least the advantages described below.

According to an aspect of the disclosure, a method of a user equipment (UE) includes identifying a position of a first symbol in which a synchronization signal block is transmitted through cell specific configuration information based on at least one of system information block (SIB) information or higher layer signaling; determining whether a second symbol of an uplink channel configured based on at least one of the higher layer signaling or downlink control information overlaps with the first symbol in which the synchronization signal block is transmitted; transmitting the synchronization signal block without transmitting the uplink channel in response to the determination that the second symbol of the uplink channel does not overlap with the first symbol in which the synchronization signal block is transmitted; and determining whether to transmit the uplink channel according to a predetermined condition in response to the determination that the second. symbol of the uplink channel overlaps with the first symbol in which the synchronization signal block is transmitted.

According to another aspect of the disclosure, a UE includes a transceiver; and a controller coupled with the transceiver and configured to identify a position of a first symbol in which a synchronization signal block is transmitted through cell specific configuration information based on at least one of SIB information or higher layer signaling, determine whether a second symbol of an uplink channel configured based on at least one of the higher layer signaling or downlink control information overlaps with the first symbol in which the synchronization signal block is transmitted, transmit the synchronization signal block without transmitting the uplink channel in response to the determination that the second symbol of the uplink channel does not overlap with the first symbol in which the synchronization signal block is transmitted, and determine whether to transmit the uplink channel according to a predetermined condition in response to the determination that the second symbol of the uplink channel overlaps with the first symbol in which the synchronization signal block is transmitted.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency resource of a wireless communication system, according to an embodiment;

FIG. 2 is a diagram illustrating a frame, subframe, and slot structure of a wireless communication system, according to an embodiment;

FIG. 3 is a diagram illustrating a configuration of a bandwidth part in a wireless communication system, according to an embodiment;

FIG. 4 is a diagram illustrating an uplink-downlink (UL/DL) configuration in a 5G system, according to an embodiment;

FIG. 5 is a diagram illustrating a synchronization signal block considered in a 5G system, according to an embodiment;

FIG. 6 is a diagram illustrating transmission cases of a synchronization signal block considered in a 5G system, according to an embodiment;

FIG. 7 is a diagram illustrating a base station (BS) and a UE operating in cross division duplex (XDD) in a 5G system, according to an embodiment;

FIG. 8 is a diagram illustrating an example of a two-dimensional time division duplex (TDD) configuration from the perspectives of a BS and a UE, according to an embodiment;

FIGS. 9A and 9B are diagrams illustrating methods for a UE to determine whether to transmit an uplink channel and a signal, according to various embodiments;

FIG. 10 is a diagram illustrating a method for a UE to determine whether to transmit an uplink channel and a signal with a second priority, according to an embodiment;

FIG. 11 is a diagram illustrating a method in which a UE partially receives a synchronization signal block in a second situation, according to an embodiment;

FIG. 12 is a diagram illustrating a structure of a UE in a wireless communication system, according to an embodiment; and

FIG. 13 is a diagram illustrating a structure of a BS in a wireless communication system, according to an embodiment.

### DETAILED DESCRIPTION

Various embodiments of the present disclosure are described with reference to the accompanying drawings. However, various embodiments of the present disclosure are not limited to particular embodiments, and it should be understood that modifications, equivalents, and/or alternatives of the embodiments described herein can be variously made. With regard to description of drawings, similar components may be marked by similar reference numerals.

In describing embodiments of the disclosure, descriptions related to technical contents well-known in the art and not associated directly with the disclosure will be omitted. Such an omission of unnecessary descriptions is intended to prevent obscuring of the main idea of the disclosure.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the Specification, the same or like reference numerals designate the same or like elements.

Herein, it will be understood that each block of the flowchart illustrations, and. combinations of blocks in the flowchart illustrations, can be implemented by computer program instructions. These computer program instructions can be provided to a processor of a general purpose computer, special purpose computer, or other programmable data processing apparatus to produce a machine, such that the instructions, which may be executed via the processor of the computer or other programmable data processing apparatus, create a means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to he performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact he executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed. either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may either be combined into a smaller number of elements, or divided into a larger number of elements. Moreover, the elements and “units” may be implemented to reproduce one or more central processing units (CPUs) within a device or a security multimedia card. Further, according to some embodiments, the “unit” may include one or more processors.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unclear. The terms which will be described below are terms defined in consideration of the functions in the disclosure, and may be different according to users, intentions of the users, or customs. Therefore, the definitions of the terms should be made based on the contents throughout the specification.

In the following description, a BS is an entity that allocates resources to terminals, and may be at least one of a gNode B, an eNode B, a Node B, a BS, a wireless access unit, a BS controller, and a node on a network. A terminal may include a user equipment (UE), a mobile station (MS), a cellular phone, a smartphone, a computer, or a multimedia system capable of performing communication functions. Examples of the BS and the terminal are not limited thereto.

In the following description of the disclosure, technology for receiving broadcast information from a BS by a terminal will be described. The disclosure relates to a communication technique for converging IoT technology with 5G communication systems designed to support a higher data transfer rate beyond 4G systems, and a system therefor, The disclosure may be applied to intelligent services (e.g., smart homes, smart buildings, smart cities, smart cars or connected cars, healthcare, digital education, retail business, security and safety-related services) on the basis of 5G communication technology and IoT-related technology.

In the following description, terms referring to broadcast information, terms referring to control information, terms related to communication coverage, terms referring to state changes (e.g., an event), terms referring to network entities, terms referring to messages, and terms referring to device elements, are illustratively used for the convenience of description. Therefore, the disclosure is not limited by the terms as used below, and other terms referring to subjects having equivalent technical meanings may be used.

In the following description, some of terms and names defined in the 3rd generation partnership project LTE (3GPP LTE) standards may be used for the convenience of description. However, the disclosure is not limited by these terms and names, and may be applied in the same way to systems that conform other standards.

A wireless communication system is advancing to a broadband wireless communication system for providing high-speed and high-quality packet data services using communication standards, such as high-speed packet access (HSPA) of 3GPP, LTE, evolved universal terrestrial radio access (E-UTRA), LTE-Advanced (LTE-_A), LTE-Pro, high-rate packet data (HRPD) of 3GPP2, ultra-mobile broadband (LMB), and the Institute of Electrical and Electronics Engineers (IEEE) 802.16e, as well as typical voice-based services.

As a typical example of the broadband wireless communication system, an LTE system employs an orthogonal frequency division multiplexing (OFDM) scheme in a downlink and employs a single carrier frequency division multiple access (SC-FDMA) scheme in an uplink. The uplink indicates a radio link through which a UE (or a mobile station (MS)) transmits data or control signals to a BS (eNode B), and the downlink indicates a radio link through which the BS transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users and service providers, services satisfying various requirements must be supported. The services considered in the 5G communication system include enhanced mobile broadband (eMBB) communication, mMTC, and ultra-reliability low-latency communication (URLLC).

According to an embodiment, eMBB aims at providing a data rate higher than ⁻that supported by existing LTE, LTE-A, or LTE-Pro. For example, in the 5G communication system, eMBB must provide a peak data rate of 20 Gbps in the downlink and a peak data rate of 10 Gbps in the uplink for a single BS. Furthermore, the 5G communication system must provide an increased user-perceived data rate to the UE, as well as the maximum data rate. In order to satisfy such requirements, transmission/reception technologies including a further enhanced MIMO transmission technique should be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the IoT in the 5G communication system. mMTC has requirements, such as supporting the connection of a large number of UEs in a cell, enhancement coverage of UEs, improved battery time, and a reduction in the cost of a UE, in order to effectively provide the IoT. Since the IoT provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UL supporting mMTC must be configured to be inexpensive, and may require a very long battery life-time because it is difficult to frequently replace the battery of the UE.

URLLC, which is a cellular-based mission-critical wireless communication service, may be used for remote control for robots or machines, industrial automation, unmanned aerial vehicles, remote health care, and emergency alerts. Thus, URLLC must provide communication with ultra-low latency and ultra-high reliability. For example, a service supporting URLLC must satisfy an air interface latency of less than 0.5 ms, and also requires a packet en'or rate of 10⁻⁵ or less. Therefore, for the services supporting URLLC, a 5G system must provide a transmit time interval (TTI) shorter than those of other services, and also requires a design for assigning a large number of resources in a frequency band in order to secure reliability of a communication link. However, the above-described mMTC, URLLC, and eMBB are merely examples of different service types, and service types to which the disclosure is applicable are not limited to the above examples.

The above-described services considered in the 5G communication system must be converged with each other so as to be provided based on one framework. That is, the respective services are preferably integrated into a single system and controlled and transmitted in the integrated single system, instead of being operated independently, for efficient resource management and control.

Further, in the following description of embodiments of the disclosure, an LTE, LTE-A, LTE-Pro, or NR system will be described by way of example, but the embodiments of the disclosure may be applied to other communication systems having similar backgrounds or channel types, In addition, based on determinations by those skilled in the art, the embodiments of the disclosure may be applied to other communication systems through some modifications without significantly departing from the scope of the disclosure.

Hereinafter, a frame structure of a 5G system will be described in more detail with reference to the drawings.

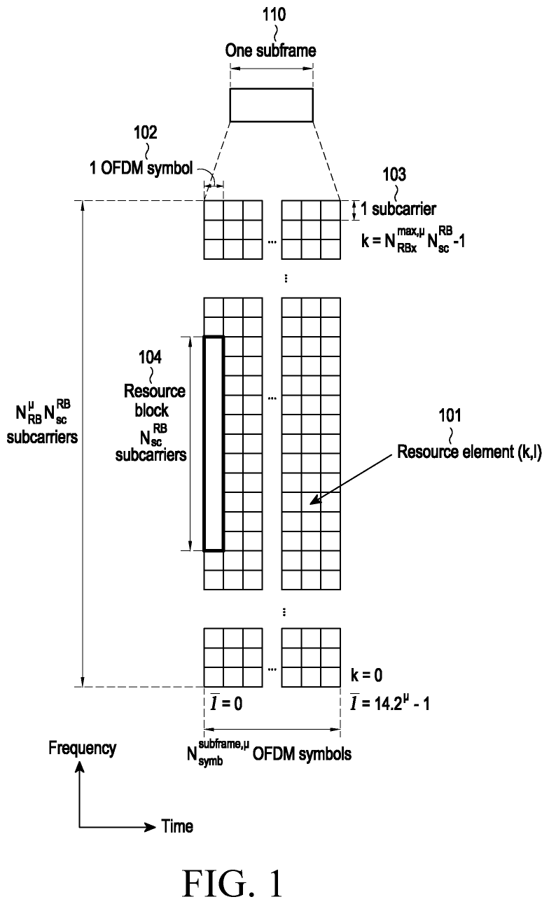

FIG. 1 is a. diagram illustrating a basic structure of a time-frequency resource of a wireless communication system, according to an embodiment.

Referring to FIG. 1, the horizontal and vertical axes of FIG. 1 represent the time domain and the frequency domain, respectively. The basic unit of resource in the time domain and frequency domain is a resource element (RE) 101, which may be defined as one orthogonal frequency division multiplexing (OFDM) symbol 102 in the time axis and may be defined as one subcarrier 103 in the frequency axis. In the frequency domain, N_{SC}^{RB} (e.g., 12) consecutive REs may constitute one resource block (RB) 104. In an embodiment, a plurality of OFDM symbols may constitute one subframe 110.

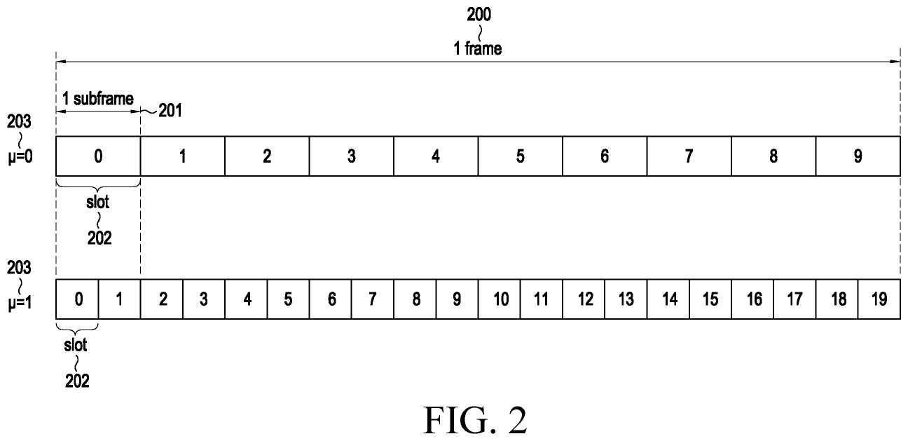

FIG. 2 is a diagram illustrating a frame, a subframe, and a slot structure of a wireless communication system, according to an embodiment. Referring to FIG. 2, one frame 200 may be configured with one or more subframes 201, and one subframe 201 may be configured with one or more slots 202. For example, one frame 200 may be defined as 10 ms, and one subframe 201 may be defined as 1 ms. In this case, one frame 200 may consist of a total of 10 subframes 201. In addition, one slot 202 may be defined as 14 OFDM symbols. That is, the number of symbols per slot N_{symb}^{slot} may have the value of 14.

According to an embodiment, one subframe 201 may consist of one or more slots 202, and the number of slots 202 per one subframe 201 may vary according to a set value μ 203 for the subcarrier spacing. In FIG. 2, a case where the μ 203 is 0 and a case where the μ 203 is 1 are illustrated as the subcarrier spacing set value.

According to an embodiment, μ 203 is 0, one subframe 201 may consist of one slot 202, and when the μ 203 is 1, one subframe 201 may consist of two slots 202. That is, depending on the set value μ 203 for the subcarrier spacing, the number of slots per one subframe 202, Nₛₗₒₜ^{subframe,μ} may vary, and accordingly, the number of slots per one frame 201, Nₛₗₒₜ^{frame,μ} may vary. The Nₛₗₒₜ^{subframe,μ} and Nₛₗₒₜ^{frame,μ} depending on each subcarrier spacing set value μ 203 may be defined according to Table 1, below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the 5G system, it is possible for one component carrier (CC) or serving cell to consist of up to 250 or more RBs. Accordingly, in a case where a UE always receives the entire serving cell bandwidth as in LTE, the UE's power consumption may be extremely high, and to resolve this, it is possible for the BS to support the UE to change the reception area within the cell by configuring one or more bandwidth parts (BWPs) to the UE. In the 5G system, the BS may configure the “initial BVP”, which is the bandwidth of CORESET #0 (or common search space (CSS)), to the UE through the master information block (MIB). Thereafter, the BS may configure an initial BWP (a first BWP) of the UE through radio resource control (RRC) signaling, and notify at least one or more pieces of BWP configuration information that may be indicated through future downlink control information (DCI). Thereafter, the BS may indicate which band. the UE will use by announcing the BWP ID through DCI. If the UE does not receive DCI in the currently allocated BWP for more than a specific time, the UE may attempt to receive DCI by returning to the “default BWP”.

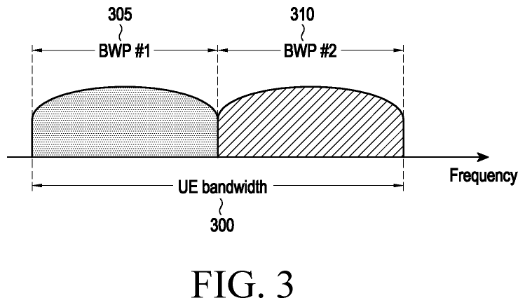

FIG. 3 is a diagram illustrating a configuration of a BWP in a wireless communication system, according to an embodiment.

Referring to FIG. 3, the UE bandwidth 300 is configured to two BWPs, i.e., BWP #1 305 and BWP #2 310, The BS may configure one or more BWPs to the UE, and may configure information as illustrated in Table 2, below, for each BWP.

TABLE 2

| | |
|---|---|
| BWP :: = | SEQUENCE { |
| bwp-Id | BWP-id, |
| locationAndBandwidth | INTEGER (1..65536) |
| subcarriorSpacing | ENUMERATED {n0,n1,n2,n3,n4,n5 }, |
| cyclicPrefix | ENUMERATED {extended} |
| } | |

Table 2 illustrates an example of information configured for the BWP, and in addition to the information configured in Table 2, various information related to the BWP may be configured in the UE. The above described information configured for the BWP may be delivered from the BS to the UE through higher layer signaling, for example, RRC signaling. At least one BWP among one or more configured BWPs may be activated. Whether the configured BWP is activated may be semi-statically delivered from the BS to the UE through RRC signaling, or may be dynamically delivered through MAC CE or DCI.

The UE, before RRC connection, may receive a configured initial BWP for initial access from the BS through an MIB. For example, in order to receive the system information (e.g., a remaining system information (RMSI) or system information block 1 (SIB1)) required for initial access through the MIB in the initial access process, the UE may receive configuration information on a control area (a control resource set (CORESET)) through which a physical downlink control channel (PDCCH) may be transmitted and configuration information on a search space (SS). The CORESET and the search space configured by the MIB may be regarded as identity (ID) 0.

The BS may notify the UE of configuration information such as frequency allocation information, time allocation information, and numerology for the CORESET #0 through the MIB. In addition, the BS may not the UE of configuration information on the monitoring period and occasion for the CORESET #0, that is, configuration information on the search space #0 through the MIB. The UE may regard the frequency domain configured as the CORESET #0 obtained through the MIB as an initial BWP for initial access. In this case, the ID of the initial BWP may be regarded as 0.

The configuration for the BWP supported by the above next generation mobile communication system (e.g., 5G or NR systems) may be used for various purposes.

In a case where the bandwidth supported by the UE is smaller than the system bandwidth, the bandwidth supported by the UE may be supported through the configuration for the BWP. For example, in Table 2, by configuring the frequency position of the MVP to the UE, the UE may transmit and receive data at a specific frequency position within the system bandwidth.

In addition, for the purpose of supporting different numerologies, the BS may configure a plurality of BWPs to the UE. For example, in order to support both data S transmission and reception using a subcarrier spacing of 15 kHz and a subcarrier spacing of 30 kHz to an arbitrary UE, two BWPs may be configured to use a subcarrier spacing of 15 kHz and 30 kHz, respectively. Different BWPs may be frequency division multiplexed (FDM), and in a case where data is transmitted/received at a specific subcarrier space, the BWP configured for the corresponding subcarrier space may be activated.

Additionally, for the purpose of reducing power consumption of the UE, the BS may configure BWPs having different sizes of bandwidth to the UE. For example, in a case where the UE supports a very large bandwidth, for example, a bandwidth of 100 MHz and always transmits and receives data to and from the corresponding bandwidth part, very large power consumption may occur. In particular, it may be very inefficient in terms of power consumption for the UE to monitor the downlink control channel for an unnecessarily large bandwidth of 100 MHz in a situation in which there is no traffic. Accordingly, for the purpose of reducing power consumption of the UE, the BS may configure a BWP of a relatively narrow bandwidth to the UE, for example, a BWP of 20 MHz. in the absence of traffic, the UE may monitor in a MVP of 20 MHz, and when data is generated, the UE may transmit/receive data by using the BWP of 100 MHz according to the instruction of the BS.

In the method of configuring the BWP described above, the UEs before the RRC connection may receive the configuration information on the initial BWP through the MIB in the initial access process. For example, the UE may receive a CORESET configured for a downlink control channel through which DCI scheduling SIB may be transmitted, from the MIB of the physical broadcast channel (PBCH), In this case, the bandwidth of the CORESET configured by the MIB may be regarded as an initial bandwidth part, and through the configured initial BWP, the UE may receive a physical downlink shared channel (PDSCH) through which the SIB is transmitted. In addition to the purpose of receiving the SIB, the initial BWP may be utilized for other system information (OSI), paging, or random access.

In a case where one or more BWPs are configured to the UE, the BS may instruct the UE to change, switch, or transit the BWP by using a BWP indicator field in DCI. For example, in a case where the currently activated BWP of the UE in FIG. 3 is BWP #1 305, the BS may indicate to the UE the BWP #2 310 by the BWP indicator in the DCI, and the UE may perform a BWP change to the BWP #2 310 indicated by the BWP indicator in the received DCI.

As described above, because the DCI-based BWP change may be indicated by the DCI scheduling the PDSCH or physical uplink shared channel (PUSCH), the UE should be able to receive or transmit the PDSCH or PDSCH scheduled by the corresponding DCI at the changed BWP without difficulty when the UE receives a BWP change request. To this end, the standard stipulates requirements for the delay time (T_{BWP}) required when the BWP is changed, and may be defined, for example, according to Table 3, below.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

Referring to Table 3, the requirement for the BWP change delay time may support type 1 or type 2 according to the capability of the UE, The UE may report the supportable delay time type to the BS.

In a case where the UE receives the DCI including the BWP change indicator in slot n according to the requirement for the BWP change delay time described above, the UE may complete the change to the new BWP indicated by the BWP change indicator at a time point not later than slot n+T_{BWP}, and transmit and receive the data channel scheduled by the corresponding DCI in the changed new BWP. In a case where the BS intends to schedule the data channel with a new BWP, the time domain resource allocation for the data channel may be determined based on the BWP change delay time (T_{BWP}) of the UE. That is, when the BS schedules a data channel with a new BWP, in a method of determining time domain resource allocation for the data channel, the BS may schedule the corresponding data channel after the BWP change delay time. Accordingly, the UE may not expect that the DCI indicating the BWP change indicates a slot offset (K0 or K2) value smaller than the BWP change delay time.

In a case where the UE receives DCI (e.g., DCI format 1_1 or DCI format 0_1) indicating a BWP change, the UE may not perform any transmission or reception during the time interval from the third symbol of the slot in which the PDCCH including the corresponding DCI is received to the start point of the slot indicated by the slot offset (K0 or K2) value indicated by the time domain resource allocation indicator field in the corresponding DCI. For example, if the UE receives a DCI indicating a BWP change in slot n, and the slot offset value indicated by the DCI is K, the UE may not perform any transmission or reception from the third symbol of slot n to the previous symbol of slot n+K (i.e., the last symbol of slot n+K−1).

In the 5G system, the downlink signal transmission interval and the uplink signal transmission interval may be dynamically changed, To this end, the BS may indicate to the UE whether each of the OFDM symbols constituting one slot is a downlink symbol, an uplink symbol, or a flexible symbol through a slot format indicator (SFI). Here, the flexible symbol may mean not both a downlink symbol and an uplink symbol, or a symbol that may be changed to a downlink symbol or uplink symbol by UE-specific control information or scheduling information. In this case, the flexible symbol may include a gap guard required in the process of switching from downlink to uplink.

Upon receiving the SFI, the UE may perform a downlink signal reception operation from the BS in a symbol indicated by the downlink symbol, and may perform an uplink signal transmission operation to the BS in a symbol indicated by the uplink symbol. For a symbol indicated as a flexible symbol, the UE may perform at least a PDCCH monitoring operation, and through another indicator, for example, DCI, the UE may perform a downlink signal reception operation (e,g., when receiving DCI format 1_0 or DCI format 1_1) from the BS in the flexible symbol or an uplink signal transmission operation (e.g., when receiving DCI format 0_0 or DCI format 0_1) to the BS.

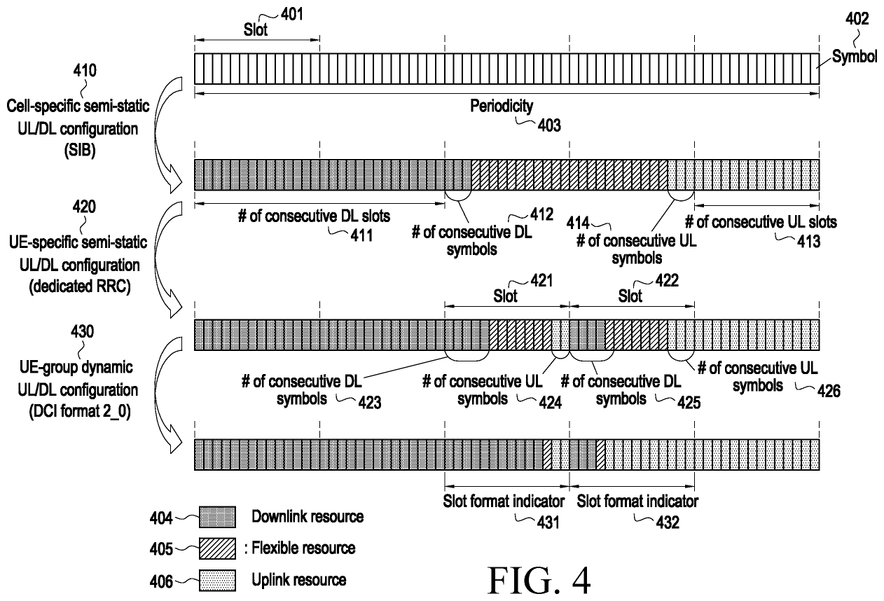

FIG. 4 is a diagram illustrating an UL/DL configuration in a 5G system, according to an embodiment. FIG. 4 illustrates an embodiment in which UL/DL configuration of symbols/slots is performed in three steps.

Referring to FIG. 4, in the first step, UL/DL of a symbol/slot may be configured through cell-specific configuration information 410, for example, system information such as SIB, for semi-statically configuring UL/DL. Specifically, the cell-specific UL/DL configuration information 410 in the system information may include UL/DL pattern information and information indicating a reference subcarrier spacing. The UL/DL pattern information may indicate the transmission periodicity of each pattern 403, the number of consecutive full DL slots at the beginning of each DL/UL pattern 411, the number of consecutive DL symbols in the beginning of the slot following the last full DL slot 412, the number of consecutive full UL slots at the end of each DL-UL pattern 413, and the number of consecutive UL symbols in the end of the slot preceding the first full UL slot 414. In this case, the UE may determine a slot/symbol not indicated by uplink or downlink as a flexible slot/symbol.

In the second step, the UE-specific configuration information 420 delivered through higher layer signaling (e.g., RRC signaling) for UE only may indicate symbols to be configured as downlink or uplink in flexible slots or slots 421 and 422 including flexible symbols. For example, the UE-specific UL/DL configuration information 420 may include a slot index indicating the slots 421 and 422 including flexible symbols, the number of consecutive DL symbols in the beginning of the slot 423 and 425, and the number of consecutive UL symbols in the end of the slot 424 and 426, or may include information indicating the entire downlink or information indicating the entire uplink for each slot. In this case, the symbol/slot configured as uplink or downlink through the cell specific configuration information 410 of the first step cannot be changed to downlink or uplink through UE-specific higher layer signaling 420.

In the last step, in order to dynamically change the downlink signal transmission interval and the uplink signal transmission interval, the downlink control information of the downlink control channel include a SFI 430 indicating whether each symbol is a. downlink symbol, an uplink symbol, or a flexible symbol in each slot among a plurality of slots starting from the slot in which the UE detects the DCI. In this case, for the symbol/slot configured with uplink or downlink in the first and second steps, the SFI cannot indicate that the symbol/slot are downlink or uplink. The slot format of each slot 431 and 432 including at least one symbol that is not configured as uplink or downlink in the first and second steps may be indicated by the corresponding DCI.

The SH may indicate UL/DL configuration for 14 symbols in one slot as illustrated in Table 4, below. The SFI may be simultaneously transmitted to a plurality of UEs through a UE group (or cell) common control channel. In other words, the DCI including the SFI may be transmitted through PDCCH scrambled with a cyclic redundancy check (CRC) by an identifier different from a UE-specific cell-RNTI (C-RNTI), for example, SFI-RNTI. The DCI may include a SFI for one or more slots, that is, N slots. Here, the value of N may be an integer greater than 0, or a value set by the UE through higher layer signaling from the BS among a set of predefined possible values, such as 1, 2, 5, 10, or 20. The size of the SH may be set by the BS to the UE through higher layer signaling. Table 4 is a table explaining the contents of SFI.

TABLE 4

| | Number of symbol(s) in one slot (or index) | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 9 | F | F | F | F | F | F | F | F | F | F | F | F | U | U |
| 19 | D | F | F | F | F | F | F | F | F | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on idd-UL-DL- |
| | ConfigurationCommon, or tdd-IL-DL-ConfigurationDedicated and, |
| | if any, on detected DCI formats |

In Table 4, D refers to a downlink symbol, U refers to an uplink symbol, and F refers to a flexible symbol. According to Table 4, the total number of supportable slot formats for one slot is 256. The maximum size of information bits that may be used for slot format indication in the 5G system is 128 bits, and the BS may set maximum size to the UE through higher layer signaling, for example, “dci-PayloadSize”.

Hereinafter, DCI in a next-generation mobile communication system (e.g., 5G or NR system) will be described in detail.

In a next generation mobile communication system, scheduling information on uplink data (or PUSCH) or downlink data (or PDSCH) may be transmitted from a BS to a UE through DCI. The UE may monitor a DCI format for fallback and a DCI format for non-fallback for PUSCH or PDSCH, The DCI format for fallback may consist of a fixed field predefined between the BS and the UE, and the DCI format for non-fallback may include a configurable field.

The DCI may be transmitted through a physical downlink control channel (PDCCH) after a channel coding and modulation process. A cyclic redundancy check (CRC) may be attached to the DCI message payload, and the CRC may be scrambled with a radio network temporary identifier (RNTI) corresponding to the identity of the UE. Different RNTIs may be provided according to the purpose of the DCI message, for example, UE-specific data transmission, a power control command, or a random access response may be used for scrambling of a CRC attached to payload of DCI message. That is, the RNTI is not explicitly transmitted, but may be included in the CRC calculation process and transmitted. Upon receiving the DCI message transmitted over the PDCCH, the UE may identify the CRC by using the assigned RNTI. If the CRC identification result is correct, the UE may recognize that the message has been transmitted to the UE.

DCI scheduling a PDSCH for SI may be scrambled with SI-RNTI. DCI scheduling a PDSCH for a random access response (RAR) message may be scrambled with an RA-RNTI. DCI scheduling a PDSCH for a paging message may be scrambled with a P-RNTI, DCI notifying a SFI may be scrambled with an SFI-RNTI, DCI notifying a transmit power control (TPC) may be scrambled with TPC-RNTI. DCI for scheduling UE-specific PDSCH or PUSCH may be scrambled with cell RNTI (C-RNTI).

DCI format 0_0 may be used as a fallback DCI for scheduling PUSCH, and in this case, CRC may be scrambled with C-RNTI. In an embodiment, DCI format 0_0 in which CRC is scrambled with C-RNTI may include information as illustrated in Table 5, below.

TABLE 5
- Identifier for DCI formats - [1] bit
- Frequency domain resource assignment - [|log₂(N_{RB}^{UL,BWP} (N_{RB}^{UL,BWP} + 1)/2)|] bits
- Time domain resource assignment - X bits
- Frequency hopping flag - 1 bit
- Modulation and coding scheme - 5 bits
- New data indicator - 1 bit
- Redundancy version - 2 bits
- HARQ process number - 4 bits
- TPC command for scheduled PUSCH - [2] bits
- UL/SUL indicator - 0 or 1 bit

DCI format 0_1 may be used as a non-fallback DCI for scheduling PUSCH, and in this case, CRC may be scrambled with C-RNTI. In an embodiment, DCI format 0_1 in which CRC is scrambled with C-RNTI may include information as illustrated in Table 6, below.

```
TABLE 6
- Carrier indicator - 0 or 3 bits
- UL/SUL indicator - 0 or 1 bits
- Identifier for DCI formats - [1] bits
- bandwidth part indicator - 0, 1 or 2 bits
- Frequency domain resource assignment
  •For resource allocation type 0, [N_{RB}^{UL,BWP}/P] bits
  •For resource allocation type 1, [log₂(N_{RB}^{UL,BWP}(N_{RB}^{UL,BWP} + 1)/2)] bits
- Time domain resource assignment - 1, 2, 3, or 4 bits
- VRB-to-PRB mapping - 0 or 1 bit, only for resource allocation type 1.
  •0 bit if only resource allocation type 0 is configured:
  •1 bit otherwise.
- Frequency hopping flag - 0 or 1 bit, only for resource allocation type 1.
  •0 bit if only resource allocation type 0 is configured:
  •1 bit otherwise.
- Modulation and coding scheme - 5bits
- New data indicator - 1 bit
- Redundancy version - 2 bits
- HARQ process number - 4 bits
- 1^{st} downlink assignment index - 1 or 2 bits
  •1 bit for semi-static HARQ-ACK codebook:
  •2 bits for dynamic HARQ-ACK codebook with single HARQ-ACK codebook.
- 2^{nd} downlink assignment index -0 or 2 bits
  •2 bits for dynamic HARQ-ACK codebook with two HARQ-ACK sub-codebooks;
  •0 bit otherwise.
- TPC command for scheduled PUSCH - 2 bits
- SRS resource indicator - [log₂(Σₖ₌₁^{L}^{ₘₐₓ}(ₖ^{N}^{_{SRS}}))] or [log₂(N_{SRS})] bits
  •[log₂(Σₖ₌₁^{L}^{ₘₐₓ}(ₖ^{N}^{_{SRS}}))] bits for non-codebook based PUSCH transmission
  •[log₂(N_{SRS})] bits for codebook based PUSCH transmission
- Precoding information and number of layers - up to 6 bits
- Antenna ports - up to 5 bits
- SRS request - 2 bits
- CSI request - 0, 1, 2, 3, 4, 5, or 6 bits
- CBG transmission information - 0, 2, 4, 6, or 8 bits
- PTRS-DMRS association - 0 or 2 bits
- beta_offset indicator - 0 or 2 bits
- DMRS sequency initialization - 0 or 1 bit
```

DCI format 1_0 may be used as a fallback DCI for scheduling PDSCH, and in this case, CRC may be scrambled with C-RNTI. DCI format 1_0 in which CRC is scrambled with C-RNTI may include information as illustrated in Table 7, below.

TABLE 7
- Identifier for DCI formats - [1] bit
- Frequency domain resource assignment - [|log₂(N_{RB}^{DL,BWP}(N_{RB}^{DL,BWP} + 1)/2)|] bits
- Time domain resource assignment - X bits
- VRB-to-PRB mapping - 1 bit
- Modulation and coding scheme - 5bits
- New data indicator - 1 bit
- Redundancy version - 2 bits
- HARQ process number - 4 bits
- Downlink assignment index - 2 bits
- TPC command for scheduled PUCCH - [2] bits
- PUCCH resource indicator - 3 bits
- PDSCH-to-HARQ feedback timing indicator - [3] bits

Alternatively, DCI format 1_0 may be used as DCI for scheduling PDSCH for RAR message, and in this case, CRC may be scrambled with RA-RNTI. DCI format 1_0 in which CRC is scrambled with RA-RNTI may include information as illustrated in Table 8, below.

TABLE 8
- Frequency domain resource assignment - [|log₂(N_{RB}^{DL,BWP}(N_{RB}^{DL,BWP} + 1)/2)|] bits
- Time domain resource assignment - 4 bits
- VRB-to-PRB mapping - 1 bit
- Modulation and coding scheme - 5 bits
- TB scaling - 2 bits
- Reserved bus - 16 bits

DCI format 1_1 may be used as a non-fallback DCI for scheduling PDSCH, and in this case, CRC may be scrambled with C-RNTI. DCI format 1_1 in which CRC is scrambled with C-RNTI may include information as illustrated in Table 9, below.

TABLE 9
- Carrier indicator - 0 or 3 bits
- Identifier for DCI formats - [1] bits
- Bandwidth part indicator - 0, 1 or 2 bits
- Frequency domain resource assignment
- •For resource allocation type 0, [N_{RB}^{DL,BWP}/P] bits
- •For resource allocation type 1, [log₂(N_{RB}^{DL,BWP}(N_{RB}^{DL,BWP} + 1)/2)] bits
- Time domain resource assignment - 1, 2, 3, 4 bits
- VRB-to-PRB mapping - 0 or 1 bit, only for resource allocation type 1.
- •0 bit if only resource allocation type 0 is configured:
- •1 bit otherwise
- PRB bundling size indicator - 0 or 1 bit
- Rate matching indicator - 0, 1, or 2 bits
- ZP CSI-RS trigger - 0, 1, or 2 bits
For transport block 1
- Modulation and coding scheme - 5bits
- New data indicator - 1 bit
- Redundancy version - 2 bits
For transport block 2
- Modulation and coding scheme - 5bits
- New data indicator - 1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports 4, 5 or 6 bits
- Transmission configuration indication - 0 or 3 bits
- SRS request - 2 bits
- CBG transmission information - 0, 2, 4, 6, or 8 bits
- CBG transformation information - 0 or 1 bit
- DMRS sequency initialization - 0 or 1 bit

In the 5G system, a synchronization signal block (SSB) (an SSB may be mixed with SSB, an SS block, and/or a SS/PBCH block) may be transmitted for initial access, and the synchronization signal block may be composed of a primary synchronization signal (PSS), a secondary synchronization signal (SSS), and a PBCH. In the initial access stage in which the UE accesses the system for the first time, the UE may first obtain downlink time and frequency domain synchronization from a synchronization signal through cell search and obtain a cell ID. The synchronization signal may include PSS and SSS. In addition, the UE may receive the PBCH transmitting the MIB from the BS to obtain system information related to transmission and reception, such as a system bandwidth or related control information, and basic parameter values. Based on this information, the UE may perform decoding on the PDCCH and the PDSCH to obtain the SIB. Thereafter, the UE exchanges an identity with the BS through a random access step, and initially accesses the network through steps such as registration and authentication.

Hereinafter, the synchronization signal block of the 5G system will be described in more detail with reference to the drawings.

According to an embodiment, the synchronization signal is a standard signal for cell search, and may be transmitted by applying a subcarrier spacing suitable for a channel environment, such as phase noise, etc. for each frequency band. The 5G BS may transmit a plurality of synchronization signal blocks according to the number of analog beams to be operated. PSS and SSS may be mapped over 12 RBs and. transmitted, and PBCH may be mapped over 24 RBs and transmitted. Hereinafter, a structure in which a. synchronization signal and a PBCH are transmitted in the 5G system will be described.

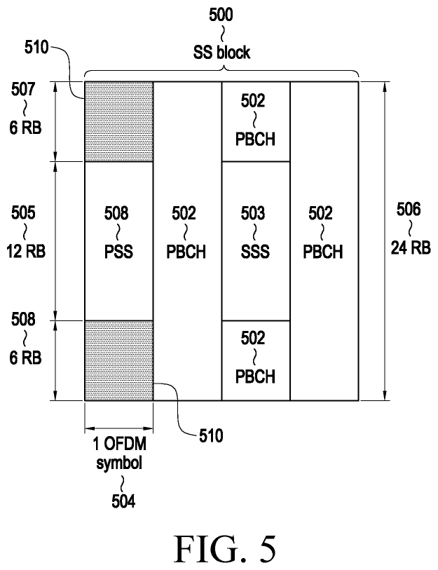

FIG. 5 is a diagram illustrating a synchronization signal block considered in a 5G system, according to an embodiment.

Referring to FIG. 5, the synchronization signal block 500 includes a PSS 501, an SSS 503, and a PBCH 502.

The synchronization signal block 500 may be mapped to four OFDM symbols in the time axis. The PSS 501 and the SSS 503 may be transmitted from 12 RBs 505 on the frequency axis and first and third OFDM symbols 504 on the time axis, respectively. In the 5G system, a total of 1008 different cell IDs may be defined, the PSS 501 may have 3 different values according to the physical layer ID of the cell, and the SSS 503 may have 336 different values. The UE may obtain one of 1008 cell IDs in combination through detection of the PSS 501 and the SSS 503. This may be expressed by Equation (1), below.

N_{ID}^{cell}=3N_{ID}⁽¹⁾+N_{ID}⁽²⁾ (1)

In Equation (1), N_{ID}⁽¹⁾ may be estimated from the SSS 503 and may have a value between 0 and 335. N_{ID}⁽²⁾ may be estimated from the PSS 501 and may have a value between 0 and 2. The value of N_{ID}^{cell}, which is a cell ID, may be estimated by a combination of N_{ID}⁽¹⁾ and N_{ID}⁽²⁾.

PBCH 502 may be transmitted from resources including 24 RB 506 on the frequency axis, and 6 RBs 507 and 508 on both sides of the synchronization signal block 500 except the center 12 RB from which SSS 503 is transmitted from the second to fourth OFDM symbols 504 on the time axis. Various system information called MIB may be transmitted from the PBCH 502, and the MIB may include information as illustrated in Table 10, below.

TABLE 10

| | |
|---|---|
| MIB :: = | SEQUENCE ( |
| systemFrameNumber | BIT STRING (SIZE (6)), |
| subCarrierSpacingCommon | ENUMERATED {scs 15or60, scs30or120}, |
| sub-SubcarrierOffset | INTERGER (0..15), |
| dmrs-TypeA-Position | ENUMERATED {pos2, pos3} |
| pdcch-ConfigSIB1 | PDCCH-ConfigSIB1, |
| cellBarred | ENUMERATED (barred, notBarred), |
| intraPredReselection | ENUMBERATED (allowed, notAllowed), |
| spare | BIT STRONG (SIZE(2)) |

}

In addition, the PBCH payload and the PBCH demodulation reference signal (DMRS) may include the following synchronization signal block information:
Synchronization signal block information: The offset of the frequency domain of the synchronization signal block is indicated through 4 bits (ssb-SubcarrierOffset) in the MIB, The index of the synchronization signal block including the PBCH may be indirectly obtained through decoding of the PBCH DMRS and PBCH. More specifically, in the frequency band below 6 GHz, 3 bits obtained through decoding of the PBCH DMRS indicate the synchronization signal block index, and in the frequency band above 6 GHz, 3 bits obtained through decoding of the PBCH DMRS and 3 bits obtained from PBCH decoding included in the PBCH payload, a total of 6 bits, indicate the synchronization signal block index including the PBCH.

In addition, the PBCH payload may include the following additional information:
PDCCH information: The subcarrier spacing of the common downlink control channel is indicated through 1 bit (subCarrierSpacingCommon) in the MIB, and control resource set (CORESET) and time-frequency resource configuration information of the search space are indicated through 8 bits (pdcch-ConfigSIB1).
System frame number (SFN): 6 bits (systemFrameNumber) in the MIB are used to indicate a part of the SFN. Least significant bit (LSB) 4 bits of SFN are included in the PBCH payload, so that the UE may indirectly obtain the LSB 4 bits through PBCH decoding.
Timing information in radio frame: The UE may indirectly identify whether the synchronization signal block is transmitted from the first or second half frame of the radio frame with 1 bit (half frame) included in the synchronization signal block index and PBCH payload and obtained through PBCH decoding.

Because the transmission bandwidth (12 RB 505) of the PSS 501 and the SSS 503 and the transmission bandwidth (24 RB 506) of the PBCH 502 are different from each other, in the first OFDM symbol 504 in which the PSS 501 is transmitted within the PBCH 502 transmission bandwidth, there are 6 RBs 507 and 508 on both sides except for the central 12 RB through which the PSS 501 is transmitted, and the area 510 may be empty or used to transmit other signals.

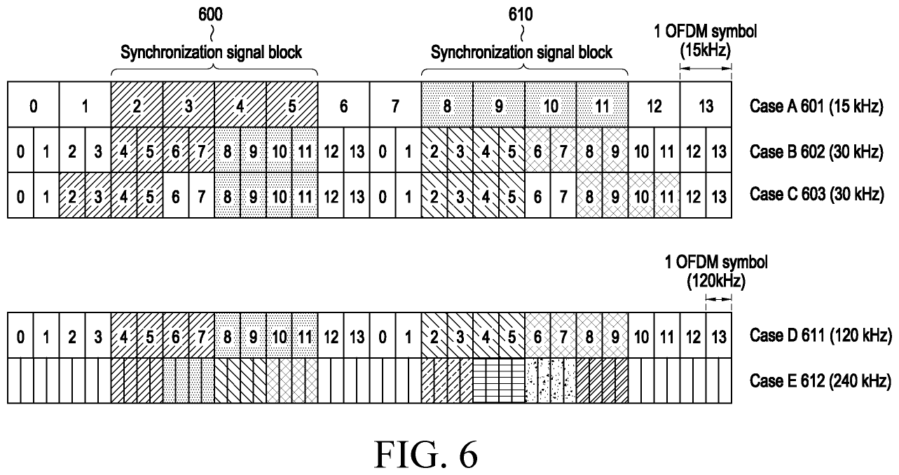

All of the synchronization signal blocks 500 may be transmitted using the same analog beam. That is, the PSS 501, the SSS 503, and the PINCH 502 may all be transmitted through the same beam. The analog beam has a characteristic that cannot be applied differently to different frequency axes, and the same analog beam is applied to all frequency axis RB within a specific OFDM symbol to which a specific analog beam is applied. That is, all four OFDM symbols in which the PSS 501, the SSS 503, and the PBCH 502 are transmitted may be transmitted through the same analog beam. FIG. 6 is a diagram illustrating transmission cases of a synchronization signal block considered in a 5G system, according to an embodiment.

Referring to FIG. 6, subcarrier spacing (SCS) of 15 kHz, 30 kHz, 120 kHz and 240 kHz may be used for transmission of synchronization signal blocks 600 and 610 consisting of four OFDM symbols in the 5G system. At 15 kHz, 120 kHz, and 240 kHz subcarrier spacings, there may be one transmission case (case A 601, case D 611, and case E 612) for synchronization signal blocks 600 and 610, respectively, and in the 30 kHz subcarrier spacing, there may be two transmission cases (case B 602 and case C 603) for the synchronization signal (SS) blocks 600 and 610.

In case A 601 at the subcarrier spacing of 15 kHz, a maximum of two synchronization signal blocks may be transmitted within 1 ms time (or, when 1 slot consists of 14 OFDM symbols, it corresponds to 1 slot length). In a frequency band of 3 GHz or less, a maximum of 4 synchronization signal blocks may be transmitted from two consecutive slots, and in a frequency band greater than 3 GHz and less than or equal to 6 GHz, a maximum of 8 synchronization signal blocks may be transmitted from 4 consecutive slots.

In case B 602 and case C 603 at the subcarrier spacing of 30 kHz, a maximum of four synchronization signal blocks may be transmitted within 1 ms time. In a frequency band of 3 GHz or less, a maximum of 4 synchronization signal blocks may be transmitted from two consecutive slots, and in a frequency band greater than 3 GHz and less than or equal to 6 GHz, a maximum of 8 synchronization signal blocks may be transmitted from 4 consecutive slots.

In case D 611 at subcarrier spacing of 120 kHz, the synchronization signal block may be transmitted only in a frequency band of 6 GHz or higher. In a frequency band of 6 GHz or higher, a maximum of 64 synchronization signal blocks may be transmitted from 32 discontinuous slats.

In case E 612 at subcarrier spacing of 240 kHz, the synchronization signal block may be transmitted only in a frequency band of 6 GHz or higher. In a frequency band of 6 GHz or higher, a maximum of 64 synchronization signal blocks may be transmitted from 32 discontinuous slots.

According to an embodiment, different analog beams may be applied to the synchronization signal block 600 and the synchronization signal block 610 in case A 601 at a subcarrier spacing of 15 kHz. That is, the same beam may be applied to all 2 to 5 OFDM symbols to which the synchronization signal block 600 is mapped, and the same beam may be applied to all 8 to 11 OFDM symbols to which the synchronization signal block 610 is mapped. In the 6th, 7th, 12th, and 13th OFDM symbols to which the synchronization signal block is not mapped, which beam will be used may be freely determined by the BS. The different analog beam application methods according to the above-described synchronization signal block index may be applied to case B 602, case C 603, case D 611, and case E 612.

The UE may obtain the SIB after decoding the PDCCH and the PDSCH based on the system information included in the MIB obtainable from the above-described. synchronization signal block. The SIB may include at least one of uplink cell bandwidth, random access parameters, paging parameters, and parameters related to uplink power control. The UE may form a wireless link with the network through a random access process based on system information and synchronization with the network acquired in the cell search process of the cell. For random access, a contention-based or contention-free method may be used. in a case where the UE performs cell selection and re-selection in the initial access process of the cell, and moves from the RRC_IDLE (RRC idle) state to the RRC_CONNECTED (RRC connection) state, the contention-based access method may be used. The contention-free random access may S be used in a case where the BS resets uplink synchronization when downlink data arrives in a case known to the UE by transmitting a random access preamble from the UE, in the case of handover, or in the case of position measurement.

As described above, in the first step of the random access procedure, the UE may transmit a random access preamble on a physical random access channel (PRACH). Each cell has 64 available preamble sequences, and 4 long preamble formats and 9 short preamble formats may be used according to a transmission type. The UE generates 64 preamble sequences by using a root sequence index and a cyclic shift value signaled by system information, and randomly selects one sequence and uses the sequence as a preamble.

The network may inform the UE which time-frequency resource may be used for PRAM by using SIB or higher-level instrumentation signaling. The frequency resource indicates to the UE the start RB point of transmission, and the number of RBs used is determined according to the preamble format and the applied subcarrier spacing. As illustrated in Table 11, below, the time resource may inform the preset PRACH configuration period, the subframe index and start symbol including the PRACH transmission time point (may be mixed with PRACH occasion and transmission time point), and the number of PRACH transmission time points in the slot through the PRACH configuration indexes (0 to 255). Through the PRACH configuration index, the random access configuration information included in the SIB, and the index of the SSB selected by the UE, the UE may identify time and frequency resources for transmitting the random access preamble. and transmit the selected sequence as the preamble to the BS.

TABLE 11

| | | | | | | | Number of | |
|---|---|---|---|---|---|---|---|---|
| | | | | | | | time- | |
| | | | | | | | domain | |
| | | | | | | Number of | PRACH | |
| | | | | | | PRACH | occasions | |
| PRACH | | | | | | slots | within a | |
| Configuration | Preamble | n_{SFN} mod x = y | | Subframe | Starting | within a | PRACH | PRACH |
| Index | format | x | y | number | number | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| . . . | . . . | | | | | | | |
| 104 | A1 | 1 | 0 | 1, 4, 7 | 0 | 2 | 6 | 2 |
| . . . | . . . | | | | | | | |
| 251 | C | 1 | 0 | 2, 7 | 0 | 2 | 2 | 6 |
| 252 | C2 | 1 | 0 | 1, 4, 7 | 0 | 2 | 2 | 6 |
| 253 | C2 | 1 | 0 | 0, 2, 4, 6, 8 | 0 | 2 | 2 | 6 |
| 254 | C2 | 1 | 0 | 0, 1, 2, 3, 4, | 0 | 2 | 2 | 6 |
| | | | | 5, 6, 7, 8, 9 | | | | |
| 255 | C2 | 1 | 0 | 1, 3, 5, 7, 9 | 0 | 2 | 2 | 6 |

Next, a scheduling method of PUSCH transmission will be described. The PUSCH transmission may be dynamically scheduled by a UL grant in DCI or may be operated by configured grant Type 1 or Type 2. The dynamic scheduling indication for PUSCH transmission may be possible by DCI format 0_0 or 0_1.

The PUSCH transmission by configured grant Type 1 may be configured semi-statically through reception of configuredGrantConfig including the rrc-ConfiguredUplinkGrant, as shown below in Table 12, through higher layer signaling without receiving UL grant in DCI. The PUSCH transmission by configured grant Type 2 may be scheduled semi-continuously by UL grant in DCI after reception of pusch-Config that does not include the rrc-ConfiguredUplinkGrant, as shown below in Table 13, through higher layer signaling. In a case where the PUSCH transmission is operated by a configured grant, parameters applied to the PUSCH transmission may be applied through configuredGrantConfig that is the higher layer signaling of Table 12 except for d.ataScramblingIdentityPUSCH, txConfig, codebookSubset, maxRank, and scaling of UCI-OnPUSCH provided by pusch-Config, which is the higher layer signaling, of Table 13. If the UE is provided with the transformPrecoder configuredGrantConfig, which is the higher layer signaling of Table 12, the UE may apply tp-pi2BPSK in pusch-Config of Table 13 to PUSCH transmission operated by the configured grant.

TABLE 12

| ConfiguredGrantConfig ::= | | SEQUENCE { |
|---|---|---|
| frequencyHopping | | ENUMERATED {intraSlot, interSlot} |
| OPTIONAL, | -- NEED S | |
| cg-DMRS-Configuration | | DMRS-UplinkConfig, |
| mcs-Table | | ENUMERATED {qam256, qam64LowSE} |
| OPTIONAL, | -- NEED S | |
| mcs-TableTransformPrecoder | | ENUMERATED {qam256, qam64LowSE} |
| OPTIONAL, | -- NEED S | |
| uci-OnPUSCH | | SetupRelease { CG-UCI-OnPUSCH } |
| OPTIONAL, | -- NEED M | |
| resouresAllocation | | ENUMERATED { resourceAllocationType0, |
| resourceAllocationType1, dynamicSwitch }, | | |
| rbg-Size | | ENUMERATED {config2} |
| OPTIONAL, | -- NEED S | |
| powerControlLoopToUse | | ENUMERATED {n0, n1} |
| p0-PUSCH-Alpha | | P0-PUSCH-AlphaSetId, |
| transformPrecoder | | ENUMERATED {enabled, disabled} |
| OPTIONAL, | -- NEED S | |
| nrofHARQ-Processes | | INTEGER(1..16), |
| repK | | ENUMERATED {n1, n2, n4, n8}, |
| repK-RV | | ENUMERATED {s1-0231, s2-0303, s3-0000} |
| OPTIONAL, | -- NEED R | |

| | |
|---|---|
| periodicity | ENUMERATED ( |

| | sym2, sym7, sym1x14, sym2x14, sym4x14, |
|---|---|
| sym5x14, sym8x14, sym10x14, sym16x14, sym20x14, | |
| | sym32x14, sym40x14, sym64x14, sym80x14, |
| sym128x14, sym160x14, sym256x14, sym320x14, sym512x14, | |
| | sym640x14, sym1024x14, sym1280x14, sym2560x14, |
| sym5120x14, | |
| | sym6, sym1x12, sym2x12, sym4x12, sym5x12, |
| sym8x12, sym10x12, sym16x12, sym20x12, sym32x12, | |
| | sym40x12, sym640x12, sym80x12, sym128x12, |
| sym160x12, sym256x12, sym320x12, sym512x12, sym640x12, | |
| | sym1280x12, sym2560x12 |

},

| configuredGrantTimer | | INTEGER (1..64) |
|---|---|---|
| OPTIONAL, | -- NEED R | |
| rrc-ConfiguredUplinkGrant | | SEQUENCE { |
| timeDomainOffset | | INTEGER (0..5119), |
| timeDomainAllocation | | INTEGER (0..15), |
| frequencyDomainAllocation | | BIT STRING (SIZE(18)), |
| antennaPort | | INTEGER (0..31), |
| dmrs-SeqInitialization | | INTEGER (0..1) |
| OPTIONAL, | -- NEED R | |
| precodingAndNumberOfLayers | | INTEGER (0..63), |
| srs-ResourceIndicator | | INTEGER (0..15) |
| OPTIONAL, | -- NEED R | |
| mcsAndTBS | | INTEGER (0..31), |
| frequencyHoppingOffset | | INTEGER (1.. maxNrofPhysicalResourceBlocks−1) |
| OPTIONAL, | -- NEED R | |
| pathlossReferenceIndex | | INTEGER (0..maxNrofPUSCH-PathlossRefrenceRSs- |
| 1). | | |
| . . . | | |
| } | | |
| OPTIONAL, | -- NEED R | |

. . .
}

Next, a PUSCH transmission method be described. The DMRS antenna port for PUSCH transmission may be the same as the antenna port for sounding reference signal (SRS) transmission. The PUSCH transmission may follow a codebook-based transmission method and a non-codebook-based transmission method, respectively, depending on whether the value of txConfig in pusch-Config of Table 13, below, which is higher layer signaling, is “codebook” or “nonCodebook”.

As described above, the PUSCH transmission may be dynamically scheduled through DCI format 0_0 or 0_1 and may be semi-statically configured by the configured grant. In a case where the UE is instructed to schedule the PUSCH transmission through DCI format 0_0, the UE may perform beam setting for PUSCH transmission by using a pucch-spatialRelationInfoID corresponding to the UE-specific PUCCH resource corresponding to the minimum ID within the uplink BWP activated in the serving cell. In this case, the PUSCH transmission may be based on a single antenna port and/or on a single antenna port. The UE may not expect scheduling of PUSCH transmission through DCI format 0_0 within the BWP in which the PUCCH resource including the pucch-spatialRelationInfo is not configured. In a case where the UE has not received configured txConfig in pusch-Config of Table 13, below, the UE may not expect to be scheduled with DCI format 0_1.

TABLE 13

| PUSCH-Config ::= | | SEQUENCE { |
|---|---|---|
| dataScramblingIdentityPUSCH | | INTEGER (0.. 1023) |
| OPTIONAL, | -- Need S | |
| txConfig | | ENUMERATED {codebook, nonCodebook} |
| OPTIONAL, | -- Need S | |
| dmrs-UplinkForPUSCH-MappingTypeA | | SetupRelease { DMRS-UplinkConfig } |
| OPTIONAL, | -- Need M | |
| dmrs-UplinkForPUSCH-MappingTypeB | | SetupRelease { DMRS-UplinkConfig } |
| OPTIONAL, | -- Need M | |
| pusch-PowerControl | | PUSCH-PowerControl |
| OPTIONAL, | -- Need M | |
| frequencyHopping | | ENUMERATED {intraSlot, interSlot} |
| OPTIONAL, | -- Need S | |
| frequencyHoppingOffsetLists | | SEQUENCE (SIZE (1..4)) OF INTEGER (1.. |
| maxNoofPhsicalResourceCellBlocks−1) | | |
| OPTIONAL, | -- Need M | |
| resourceAllocation | | ENUMERATED ( resourcedAllocationType0, |
| resourceAllocationType1, dynamicSwitch), | | |
| pusch-TimeDomainAllocationList | | SetupRelease ( PUSCH- |
| TimeDomainResourceAllocationList ) | | OPTIONAL, -- Need M |
| pusch-AggregationFactor | | ENUMERATED ( n2, n4, n8 ) |
| OPTIONAL, | -- Need S | |
| mcs-Table | | ENUMERATED (qam256, qam64LowSE) |
| OPTIONAL, | -- Need S | |
| mcs-TableTransformPrecoder | | ENUMERATED (qam256, qam64LowSE) |
| OPTIONAL, | -- Need S | |
| transformPrecoder | | ENUMERATED (enabled, disabled) |
| OPTIONAL, | -- Need S | |
| codebookSubset | | ENUMERATED (fullyAndPartiallyAndNonCoherent, |
| partialAndNonCoherant, nonCoherent } | | |
| OPTIONAL, | -- Cond codebookBased | |
| maxRank | | INTEGER (1..4) |
| OPTIONAL, | -- Cond codebookBased | |
| rbg-Size | | ENUMERATED ( config2) |
| OPTIONAL, | -- Need S | |
| uci-OnPUSCH | | SetupRelease { UCI-OnPUSCH} |
| OPTIONAL, | -- Need M | |
| tp-pi2BPSK | | ENUMERATED (enabled) |
| OPTIONAL, | -- Need S | |

. . .
}

Next, codebook-based PUSCH transmission will be described. The codebook-based PUSCFI transmission may be dynamically scheduled through DCI format 0_0 or 0_1, and may operate semi-statically by a configured grant. When the codebook-based PUSCH is dynamically scheduled by DCI format 0_1 or is configured semi-statically by the configured grant, the UE may determine a precoder for PUSCH transmission based on the SRS resource indicator (SRI), the transmission precoding matrix indicator (TPMI), and the transmission rank (the number of PUSCH transmission layers).

In this case, the SRI may be given through a field SRS resource indicator in the DCI or may be configured through srs-ResourceIndicator which is higher layer signaling. When transmitting the codebook-based PUSCH, the UE may receive at least one configured SRS resource and up to two configured SRS resources. In a case where the UE is provided with an SRI through DCI, the SRS resource indicated by the corresponding SRI may refer to an SRS resource corresponding to the SRI among SRS resources transmitted before the PDCCH including the corresponding SRI. In addition, TPMI and transmission rank may be given through field precoding information and number of layers in DCI, or may be configured through precodingAndNumberOfLayers, which is an higher layer signaling. TPMI may be used to indicate the precoder applied to PUSCH transmission. In a case where the UE receives one SRS resource configured, the TPMI may be used to indicate the precoder to be applied in the configured one SRS resource. In a. case where the UE receives multiple SRS resources configured, the TPMI may be used to indicate the precoder to be applied in the SRS resource indicated through the SRI.

The precoder to be used for PUSCH transmission may be selected from an uplink codebook having the same number of antenna ports as the nrofSRS-Ports value in SRS-Config, which is an higher layer signaling. In codebook-based PUSCH transmission, the UE may determine the codebook subset based on the TPMI and the codebookSubset within the push-Config, which is the higher layer signaling. The codebookSubset in push-Config, which is the higher layer signaling, may be configured to one of “fullyAndPartialAndNonCoherent”, “partialAndNonCoherent”, or “nonCoherent” based on UE capability reported by the UE to the BS, in a case where the UE reports “partialAndNonCoherent” as UE capability, the UE may not expect the value of the higher layer signaling codebookSubset to be configured to “fullyAndPartialAndNonCoherent”. In addition, in a case where the UE reports “nonCoherent” as UE capability, the UE may not expect the value of the higher layer signaling codebookSubset to be configured to “fullyAndPartialAndNonCoherent” or “partialAndNonCoherent”. In a case where nrofSRS-Ports in SRS-ResourceSet, which is the higher layer signaling, indicates two SRS antenna ports, the UE may not expect the value of codebookSubset, which is the higher layer signaling, to be configured to “partialAndNonCoherent”.

The UE may receive one SRS resource set configured in which the value of the usage in the SRS-resource set, which is the higher layer signaling, is configured to “codebook”, and one SRS resource within the SRS resource set may be indicated through the SRI. In a case where multiple SRS resources are configured within the SRS resource set in which the usage value in the SRS-resource set, which is the higher layer signaling, is configured to “codebook”, the UE may expect that the value of nrofSRS-Ports in the SRS-resource, which is the higher layer signaling, is configured to be the same for all SRS resources.

The UE may transmit one or a plurality of SRS resources included in the SRS resource set in which the value of usage is configured to “codebook” to the BS according to upper level signaling, and the BS may select one of the SRS resources transmitted by the UE and instruct the UE to perform PUSCH transmission by using the transmission beam information of the corresponding SRS resource. in this case, in the codebook-based PUSCH transmission, the SRI is used as information on selecting an index of one SRS resource and may be included in the DCI. In addition, the BS may include information indicating the TPMI and rank to be used by the UE for PUSCH transmission in the DCI. The UE may perform PUSCH transmission by applying the indicated rank and the precoder indicated by TPMI based on the transmission beam of the corresponding SRS resource by using the SRS resource indicated by the SRI.

Next, non-codebook-based PUSCH transmission will be described. The non-codebook-based PUSCH transmission may be dynamically scheduled through DCI format 0_0 or 0_1, and may operate semi-statically by a configured grant. In a case where at least one SRS resource is configured in the SRS resource set in which the value of usage in the SRS-ResourceSet, which is the higher layer signaling, is configured to “nonCodebook”, the UE may receive the non-codebook-based PUSCH transmission scheduled through DCI format 0_1.

For the SRS resource set in which the value of usage in the SRS-ResourceSet, which is the higher layer signaling, is configured to “nonCodebook”, the UE may receive one connected and configured non-zero power CSI-RS (NZP CSI-RS resource). The UE may perform calculation on the precoder for SRS transmission through measurement of the NZP CSI-RS resource connected to the SRS resource set. If the difference between the last received symbol of the aperiodic NZP CSI-RS resource connected to the SRS resource set and the first symbol of the aperiodic SRS transmission in the UE is less than 42 symbols, the UE may not expect information on the precoder for SRS transmission to be updated.

When the value of resourceType in the SRS-ResourceSet, which is the higher layer signaling, is configured to “aperiodic”, the connected NZP CSI-RS may be indicated by the SRS request, which is a field in DCI format 0_1 or 1_1. In this case, if the connected NZP CSI-RS resource is an aperiodic NZP CSI-RS resource, it indicates that the connected NZP CSI-RS exists when the value of the field SRS request in DCI format 0_1 or 1_1 is not “00”. In this case, the corresponding DCI should not indicate cross carrier or cross BWP scheduling. In addition, if the value of the SRS request indicates the presence of the NZP CSI-RS, the corresponding NZP CSI-RS is located in the slot in which the PDCCH including the SRS request field is transmitted. In this case, the TCI states configured in the scheduled subcarrier may not be configured to quasi-co location (QCL)-TypeD.

In a case where a periodic or semi-persistent SRS resource set is configured, the connected NZP CSI-RS may be indicated through the associatedCSI-RS in the SRS-ResourceSet, which is the higher layer signaling. For non-codebook-based transmission, the UE may not expect that spatialRelationInfo, which is the higher layer signaling for SRS request, and associatedCSI-RS in SRS-ResourceSet, which is the higher layer signaling, are configured together.

In a case where a plurality of SRS resources are configured, the UE may determine the precoder to be applied to PUSCH transmission and the transmission rank based on the SRI indicated by the BS. In this case, the SRI may be indicated through a field SRS resource indicator in the DCI or may be configured through srs-ResourceIndicator, which is the higher layer signaling. Like the above-described codebook-based PUSCH transmission, in a case where the UE receives SRI through DCI, the SRS resource indicated by the corresponding SRI refers to the SRS resource corresponding to the SRI among the SRS resources transmitted before the PDCCH including the corresponding SRI. The UE may use one or a plurality of SRS resources for SRS transmission, and the maximum number of SRS resources capable of simultaneous transmission in the same symbol in one SRS resource set may be determined by the UE capability reported by the UE to the BS. In this case, the SRS resources simultaneously transmitted by the UE occupy the same RB. The UE configures one SRS port for each SRS resource. Only one SRS resource set in which the value of usage in the SRS-ResourceSet, which is the higher layer signaling, may be configured to “nonCodebook”, and up to four SRS resources for non-codebook-based PUSCH transmission may be configured.

The BS transmits one NZP-CSI-RS connected to the SRS resource set to the UE, and the UE may calculate a precoder to be used when transmitting one or a plurality of SRS resources in the corresponding SRS resource set based on the result measured when receiving the corresponding NZP-CSI-RS. The UE may apply the calculated precoder when transmitting one or a plurality of SRS resources in the SRS resource set in which usage is set to “nonCodebook” to the BS, and the BS may select one or a plurality of SRS resources among one or a plurality of SRS resources received. In this case, in non-codebook-based PUSCH transmission, the SRI indicates an index capable of representing one or a combination of a plurality of SRS resources, and the SRI may be included in the DCI. In addition, the number of SRS resources indicated by the SRI transmitted by the BS may be the number of transmission layers of the PUSCH, and the UE may transmit the PUSCH by applying the precoder applied to the SRS resource transmission to each layer.

Next, an uplink channel interference method using SRS transmission of a UE will be described. The BS may configure at least one SRS configuration for each uplink BWP to deliver configuration information on SRS transmission to the UE, and may also configure at least one SRS resource set for each SRS configuration. For example, the BS and the UE may exchange the following higher layer signaling information as follows in order to deliver information on the SRS resource set:
srs-ResourceSetId: SRS resource set index.
srs-ResourceIdList: a set of SRS resource indexes referenced by the SRS resource set.
resourceType: A time axis transmission configuration of the SRS resource referenced in the SRS resource set, which may be configured to one of “periodic”, “semi-persistent”, and “aperiodic”. If it is configured to “periodic” or “semi-persistent”, the associated CSI-RS information may be provided according to the usage of the SRS resource set. If configured to “aperiodic”, an aperiodic SRS resource trigger list and slot offset information may be provided, and associated CSI-RS information may be provided according to the usage of the SRS resource set.
usage: A configuration for the usage of the SRS resource referenced in the SRS resource set, which may be configured to one of “beamManagement”, “codebook” “nonCodebook”, and “antennaSwitching”.
alpha, p0, pathlossReferenceRS, srs-PowerControlAdjustmentStates: Provide a parameter setting for adjusting the transmission power of the SRS resource referenced in the SRS resource set.

It may be understood that the UE follows the information configured in the SRS resource set for the SRS resource included in the set of SRS resource indexes referenced in the SRS resource set.

In addition, the BS and the UE may transmit/receive: higher layer signaling information in order to deliver individual configuration information on the SRS resource. For example, the individual configuration information on the SRS resource may include time-frequency axis mapping information within the slot of the SRS resource, which may include information on frequency hopping within or between slots of the SRS resource. In addition, the individual configuration information on the SRS resource may include the time axis transmission configuration of the SRS resource, and may be configured to one of “periodic”, “semi-persistent”, and “aperiodic”. This may be limited to have the same time axis transmission configuration as the SRS resource set including SRS resource. In a case where the time axis transmission configuration of the SRS resource is configured to “periodic” or “semi-persistent”, additionally, the SRS resource transmission period and slot offset (e.g., periodicityAndOffset) may be included in the time axis transmission configuration.

The BS may activate, deactivate, or trigger SRS transmission to the UE through higher layer signaling including RRC signaling, medium access control (MAC) control element (CE) signaling, or layer 1 (L1) signaling (e.g., DCI). For example, the BS may activate or deactivate periodic SRS transmission to the UE through higher layer signaling. The BS may instruct to activate the SRS resource set in which the resourceType is configured to “periodic” through higher layer signaling, and the UE may transmit the SRS resource referenced in the activated SRS resource set. The time-frequency axis resource mapping in the slot of the transmitted SRS resource follows the resource mapping information set in the SRS resource, and the slot mapping including the transmission period and the slot offset follows the periodicityAndOffset set in the SRS resource. In addition, the spatial domain transmission filter applied to the SRS resource to be transmitted may refer to spatial relation info set in the SRS resource, or may refer to associated CSI-RS information set in the SRS resource set including the SRS resource. The UE may transmit the SRS resource in the uplink BWP activated for the periodic SRS resource activated through higher layer signaling.

The BS may activate or deactivate semi-persistent SRS transmission through higher layer signaling to the UE, The BS may instruct to activate the SRS resource set through MAC CE signaling, and the UE may transmit the SRS resource referenced in the activated SRS resource set. The SRS resource set activated through MAC CE signaling may be limited to the SRS resource set in which the resourceType is set to semi-persistent. The time-frequency axis resource mapping in the slot of the SRS resource to be transmitted follows the resource mapping information set in the SRS resource, and the slot mapping including the transmission period and the slot offset follows the periodicityAndOffset set in the SRS resource. In addition, the spatial domain transmission filter applied to the SRS resource to be transmitted may refer to spatial relation info configured in the SRS resource, or may refer to associated CSI-RS information configured in the SRS resource set including the SRS resource. In a case where spatial relation info is configured in the SRS resource, without following the configuration above, the spatial domain transmission filter may be determined by referring to configuration information on spatial relation info delivered through MAC CE signaling that activates semi-persistent SRS transmission. The UE may transmit the SRS resource within the uplink BWP activated for the semi-persistent SRS resource activated through higher layer signaling.

The BS may trigger aperiodic SRS transmission to the UE through DCI. The BS may indicate one of aperiodic SRS resource triggers (aperiodicSRS-ResourceTrigger) through the SRS request field of DCI. The UE may understand that the SRS resource set including the aperiodic SRS resource trigger indicated through DCI in the aperiodic SRS resource trigger list has been triggered among the SRS resource set configuration information. The UE may transmit the SRS resource referenced in the triggered SRS resource set. The time-frequency axis resource mapping in the slot of the SRS resource to be transmitted follows the resource mapping information configured in the SRS resource. In addition, the slot mapping of the SRS resource to be transmitted may be determined through the slot offset between the PDCCH including DCI and the SRS resource, which may refer to the value(s) included in the slot offset set configured in the SRS resource set. For example, the slot offset between the PDCCH including DCI and. the SRS resource may apply a value indicated by the time domain resource assignment field of DCI among the offset value(s) included in the slot offset set configured in the SRS resource set. In addition, the spatial domain transmission filter applied to the SRS resource to be transmitted may refer to spatial relation info configured in the SRS resource, or may refer to the associated CSI-RS information configured in the SRS resource set including the SRS resource. The UE may transmit the SRS resource within the uplink BWP activated for the aperiodic SRS resource triggered through DCI.

In a case where the BS triggers aperiodic SRS transmission through DCI to the UE, in order for the UE to transmit the SRS resource by applying the configuration information on the SRS resource, a minimum time interval between the PDCCH including the DCI triggering the aperiodic SRS transmission and the SRS to be transmitted may be required. The time interval for SRS transmission of the UE may be defined as the number of symbols between the first symbols to which the SRS resource transmitted first among the SRS resource(s) transmitted from the last symbol of the PDCCH including the DCI triggering aperiodic SRS transmission is mapped. The minimum time interval may be determined by referring to the PUSCH preparation procedure time required for the UE to prepare for PUSCH transmission. In addition, the minimum time interval may have a different value depending on where the SRS resource set including the SRS resource to be transmitted is used. For example, the minimum time interval may be determined as an N2 symbol defined based on the UE processing capability according to the capability of the UE with reference to the PUSCH preparation procedure time of the UE. In addition, considering the usage of the SRS resource set including the SRS resource to be transmitted, in a case where the usage of the SRS resource set is configured to “codebook” or “antennaSwitching”, the minimum time interval may be set as N2 symbols, and in a case where the usage of the SRS resource set is configured to “nonCodebook” or “beamManagement”, the minimum time interval may be set to N2+14 symbols. The UE may transmit the aperiodic SRS in a case where the time interval for aperiodic SRS transmission is greater than or equal to the minimum time interval, in a case where the time interval for aperiodic SRS transmission is smaller than the minimum time interval, the UE may ignore DCI triggering the aperiodic SRS.

In a 5G system, TDD is preferred over frequency-division-duplex (FDD), as TDD may be more advantageous for resolving downlink and uplink traffic imbalances and using channel reciprocity in multiple antennas. However, TDD also has fundamental problems. The first problem is that uplink coverage may be reduced. In FDD, there is no uplink transmission time limit because downlink and uplink frequency bands are divided, but in TDD, downlink and uplink times are divided, so the transmission time limit may be taken depending on traffic. In general, because most traffic is concentrated on the downlink, in TDD, time resources are more distributed in the downlink, and the UE may not be able to receive sufficient time resources available for the uplink. Therefore, in TDD, uplink coverage may be reduced. The second problem is that throughput may be reduced due to a hybrid automatic repeat request (HARQ) feedback delay caused by downlink and uplink time asymmetry. This problem may occur because, in a case where there is a lot of traffic in the downlink, the HARQ-acknowledgment (ACK) feedback is not provided until the uplink slot after the UE receives data. Accordingly, XDD has been proposed to solve the TDD coverage reduction and delay problems.

Unlike the conventional TDD operation, a BS operating in XDD may simultaneously receive downlink and uplink in different frequency bands during the same time unit or slot.

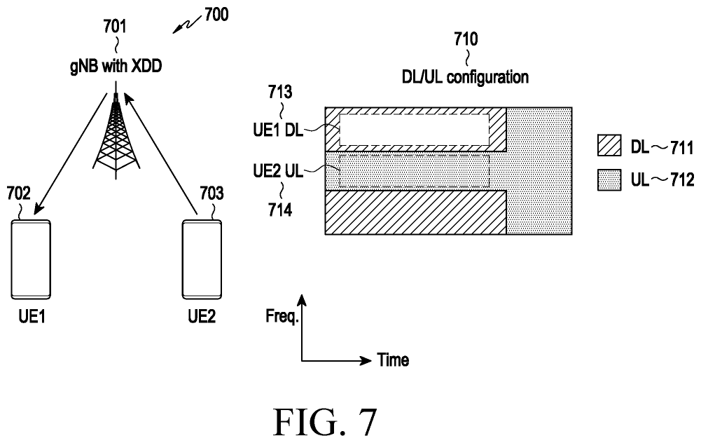

FIG. 7 is a diagram illustrating a BS and a UE operating in XDD in a 5G system, according to an embodiment, FIG. 7 illustrates that the BS performs downlink and uplink operations at the same time.

Referring to FIG. 7, in the 5G system 700, the BS 701 transmits to the UE 1 702 through the downlink 713 and receives from the UE 2 703 through the uplink 714. In addition, looking at the downlink and uplink configurations 710 from the perspective of the BS 701., as illustrated, the downlink 711 and the uplink 712 overlap at the same time point, and then both are expressed to be configured to the uplink. In addition, the downlink 713 of the UE 1 702 may be expressed as a UE1 DL 713 in the downlink and uplink configuration 710, and the uplink 714 of the UE 2 703 may be expressed as a UE2. UL 714 in the downlink and uplink configuration 710. As illustrated, a configuration capable of operating downlink and uplink within the same time as the downlink and uplink configuration 710 may be referred to as a two-dimensional TDD configuration (2D TDD configuration).

In a system operating with XDD, the BS can flexibly allocate downlink and uplink according to traffic required for two-dimensional TDD configuration, and from the perspective of the UE, because the uplink resource time is increased while maintaining the conventional technology, there may be advantages in coverage increase and delay reduction.

The difference between XDD and FDD is that the frequency interval between downlink and uplink is not wide enough to prevent adjacent channel interference. Accordingly, cross-link interference (CLI) may exist in a case where the BS transmits/receives downlink and uplink at the same time. A BS operating in XDD may reduce interference as much as possible by locating the transmitter and the receiver so that the distance between the transmitter and the receiver is sufficiently far, and by building several walls. In addition, remaining interference may be removed through self-interference cancellation (SIC). A BS operating in XDD from which CLI is removed through the above-described process may increase uplink coverage while increasing uplink allocation time through a general TDD operation. In this case, the UE may operate in the same way as the existing UE without change. From the UE's perspective, it is not visible whether the BS operates in XDD or TDD.

A BS operating in XDD may transmit and receive downlink and uplink simultaneously in the same slot, but the current TDD operating standard (e.g., Rel-15/16) may not support all the corresponding functions. For example, in the current TDD, if at least one symbol overlaps with a symbol in which a synchronization signal block configured in a higher layer (e.g., ssb-PositionsInBurst in SIB1 or ssb-PositionsInBurst ServingCellConfigCommon) is transmitted, the UE cannot transmit PUSCH, PUCCH, MACH and/or SRS. In this case, the UE may not expect to receive an uplink instruction from the higher layer parameter tdd-UL-DL-ConfigurationCommon or tdd-UL-DL-ConfigurationDedicated, and may not expect to detect DCI format 2_0 including the SFI-index field value indicating uplink in the symbol in which the synchronization signal block is transmitted. In other words, according to the current 5G standard (Rel-15/16), the symbol in the slot in which the transmission of the synchronization signal block is indicated is always configured to the downlink, and the UE cannot transmit any channel or signal from the corresponding symbol. The synchronization signal block synchronizes the UE, provides essential system information, and is configured to be received by the UE because of the importance of being a QCL source for other channels.

If the BS operates in TDD, there is no problem in the above description, but, if the BS operates in XDD, in a case where the synchronization signal block is transmitted from the downlink, the UE must receive the synchronization signal block and thus cannot be allocated uplink resources. For example, in a case where a synchronization signal block is received from another frequency band while the UE is transmitting from several uplink slots by using repeated PUSCH transmission, the UE receives the synchronization signal block without performing repeated PUSCH transmission. In this case, there may be a possibility that the UE cannot secure coverage because sufficient time is not allocated for a repeated PUSCH transmission. Because the motivation for introducing XDD is to increase coverage and decrease delay, the need to become UE-friendly in the above case is required. For example, in a case where an uplink channel or signal for which repeated transmission is performed for the purpose of securing coverage and a synchronization signal block overlap in the same symbol, the UE may increase coverage in the direction of transmitting an uplink channel or a signal without receiving a synchronization signal block.

In the disclosure, it is assumed that the downlink and the uplink are transmitted at different frequencies but overlap at the same time in a two-dimensional TDD configuration.

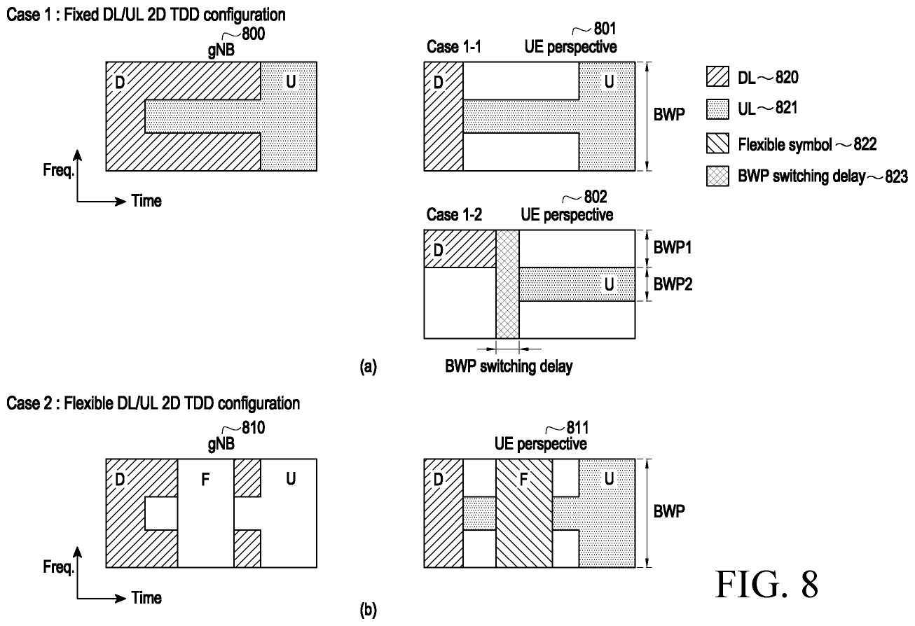

FIG. 8 is a diagram illustrating an example of two-dimensional TDD configuration from the perspectives of a BS and a UE, according to an embodiment. (a) of FIG. 8 illustrates a two-dimensional TDD configuration 800 from the BS perspective and two-dimensional TDD configurations 801 and 802 from the UE perspective in Case 1, which is a fixed uplink and downlink two-dimensional TDD configuration, and (b) of FIG. 8 illustrates a two-dimensional TDD configuration 810 from the BS perspective and a two-dimensional TDD configuration 811 from the UE perspective in Case 2, which is a flexible uplink/downlink two-dimensional TDD configuration.

Referring to FIG. 8, in Case 1, the BS may configure the fixed uplink/downlink two-dimensional TDD to the UE through higher layer signaling (e.g., SIB and RRC) or DCI format 2_0 including the SFI_index field. In this case, Case 1-1 includes a case in which the UE receives a plurality of MVPs having the same center frequency. In Case 1-1, the UE switches from the downlink 820 to the uplink 821-1 having a narrower bandwidth, and then to the uplink 821-2 having a wider bandwidth. Each transition time may be negligibly short because the center frequency is the same. In Case 1-2, unlike Case 1-1, the UE is configured in different BWPs for downlink and uplink, and has a different center frequency. Therefore, when switching from downlink to uplink, a BWP switching delay 823 may occur.

In Case 2, the BS may designate the flexible symbol 822 to the UE through higher layer signaling (e.g., SIB and RRC) or DCI format 2_0 including the SH index field. When the UE does not receive configuration of PDCCH search including the DCI format 2_0 in the flexible symbol configured in the higher layer parameter, for example in tdd-UL-DL-ConfigurationCommon or tdd-UL-DL-ConfigurationDedicated, the UE may receive a corresponding channel or signal if DCI for scheduling PDSCH or CST-RS is configured. In the above configuration, if the UE is configured with DCI, RAR UL grant, fallbackRAR UL grant or successRAR scheduling PUSCH, PUCCH, PRAM or SRS, the UE may receive the corresponding channel or signal.

On the other hand, the UE may know information on the synchronization signal block with a higher layer parameter through SIB information or cell-specific configuration information through higher layer signaling. In this case, the UE may receive configuration of the repeated transmission configured in the higher layer or reception of a channel or signal that transmits on a periodic or semi-permanent basis to the symbol that receives the synchronization signal block. Alternatively, a contention-free PRACH may be configured according to circumstances. In the 5G system operating with existing TDD, the UE preferentially receives the synchronization signal block, but in a system operating in XDD, if a specific condition is satisfied, the UE may transmit a channel or a signal in the uplink without receiving a synchronization signal block transmitted from the downlink. Here, the channel and signal included in the specific condition may include a case of a channel or signal that is configured by a higher layer and transmitted by the UE on a repetitive or periodic/semi-permanent basis. In this case, the channel and signal that are dynamically allocated and transmitted may be excluded because they can be transmitted without overlapping with the synchronization signal block through scheduling, and for the same reason, the channel and signal that are configured in a higher layer and transmitted in an aperiodic manner may also be excluded. In addition, the channel and signal included in the specific condition may also include a contention-free PRACH, In this case, the contention-based PRACH may be excluded because it mainly operates in TDD. If the UE does not receive the synchronization signal block by satisfying the specific condition, a synchronization mismatch problem or a delay in system information reception may occur, Therefore, a method for synchronization signal block compensation is also required.

Hereinafter, in the disclosure, the above-described specific condition will be described in detail in an embodiment, and the synchronization signal block compensation method will be described in detail in another embodiment.

Hereinafter, the disclosure provides a method and apparatus for transmitting and receiving a channel and a signal between a BS and a UE for coverage improvement, but the disclosure may also be applied to a method and apparatus for transmitting and receiving a channel and a signal for services (e,g., URLLC) that may be provided in the 5G system for purposes other than coverage improvement. In addition, hereinafter, the disclosure provides a method and apparatus for transmitting and receiving a channel and a signal between a BS and a UE in an XDD system, but the disclosure is not limited to the XDD system, and may also be applied to a method and apparatus for transmitting and receiving a channel and a signal in other division duplex systems that may be provided in the 5G system.

According to an embodiment, a method in which a UE transmits an uplink channel and a signal without receiving a synchronization signal block under a specific condition is provided.

Accordingly, Priority Condition 1 and Priority Condition 2 in the XDD system will be described in detail.

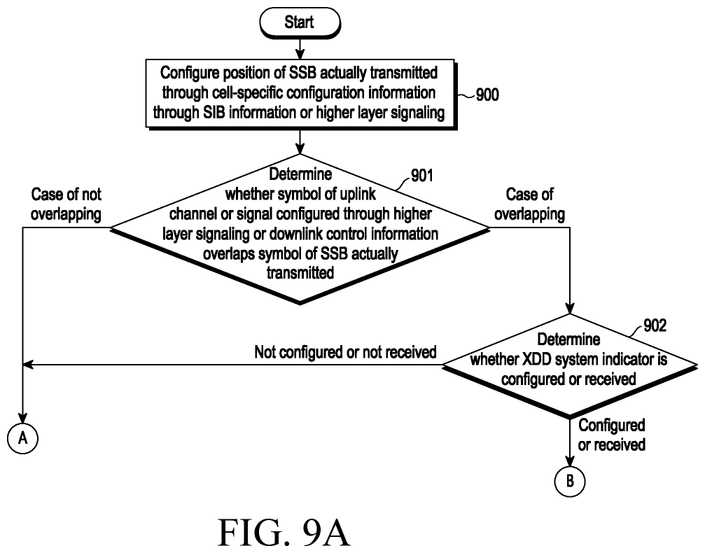

FIGS. 9A and 9B are diagrams illustrating methods for a UE to determine whether to transmit an uplink channel and a signal, according to various embodiments.

Referring to FIGS. 9A and 9B, in step 900, the UE identifies the symbol position in the time domain of the synchronization signal block actually transmitted by the BS based on the received SIB information or cell-specific configuration information through higher layer signaling. In step 901, the UE determines whether an uplink channel or signal configured or scheduled through higher layer signaling (e.g., RRC or MAC-CE) or DC1 format 0_0, 0 1_0, 1_1, or 2_3, for example, an uplink data channel, an uplink control channel, a random access channel, or a transmission symbol of a sounding reference signal, overlaps with a symbol of a synchronization signal block on a time domain basis.

In step 901, in a case where the transmission symbols of the configured or scheduled uplink channel or signal do not overlap all the symbols in the time domain with the synchronization signal block, the UE proceeds to step 903 and receives a synchronization signal block based on the received SIB information or cell-specific configuration information through higher layer signaling. In step 901, in a case where the transmission symbols of the configured or scheduled uplink channel or signal overlap the synchronization signal block and the time domain in at least one symbol, the UE proceeds to step 902 and determines whether the XDD system indicator is configured or received.

In step 902, in a case where the UE has not configured or has not received the XDD system indicator, the UE proceeds to step 903 and receives a synchronization signal block based on the received SIB information or cell-specific configuration information through higher layer signaling. In step 902, in a case where the UE has configured or has received the XDD system indicator, the UE may proceed to step 904 and determines whether to configure or receive an additional higher layer signaling field that configures or indicates priority reception of a synchronization signal block, additional 1-bit DCI (e.g., SSB_priorityInXDD) configuring or indicating priority reception of a synchronization signal block, or a measurement usage for the synchronization signal block.

In step 904, in a case where the UE has configured or received the additional higher layer signaling field that configures or indicates priority reception of a synchronization signal block, additional I-bit DCI (e.g., SSB_priorityInXDD) configuring or indicating priority reception of a synchronization signal block, or measurement usage for the synchronization signal block, the UE may proceed to step 903 and receives a synchronization signal block based on the received SIB information or cell-specific configuration information through higher layer signaling.

In step 904, in a case where the UE has not configured or received the additional higher layer signaling field that configures or indicates priority reception of a synchronization signal block, additional 1-bit DCI configuring or indicating priority reception of a synchronization signal block, or measurement usage for the synchronization signal block, the UE proceeds to step 905 and determines whether uplink channels or signals configured or scheduled through higher layer signaling or DCI overlap in the same symbol. If step 905 does not exist and uplink channels or signals configured or scheduled through higher layer signaling or DCI overlap in the same symbol, the UE may configure the priority of an uplink channel or signal according to the current TDD operation standard (e.g., Rel-15/16), and may determine the synchronization signal block and priority according to Priority Condition 1 to be described later. In this case, if an uplink channel or a signal having a lower priority has a higher priority than a synchronization signal block according to the current TDD operation standard while the uplink channel or signal having the highest priority according to the current TDD operation standard has a lower priority than the synchronization signal block, there is a problem in that the UE cannot be allocated an uplink according to the current TDD operation standard although the UE is able to transmit the uplink channel and the signal having a higher priority than the synchronization signal block. For example, in a case where the UE configures or schedules repeated PRACH and PUSCH transmission, and the two channels overlap in the same symbol, PUSCH repetition is dropped. In this case, if the PRACH is low and the repeated. PUSCH transmission is high in priority with the synchronization signal block, the UE cannot receive uplink allocation because the PRACH is low in priority with the synchronization signal block, In order to prevent this, step 905 is introduced and in a case where repeated PRACH and PUSCH transmission overlap in the same symbol as in the above example, according to Priority Condition 2, which will be described later, the UE does not transmit the PRACH by giving priority to a repeated PUSCH transmission over the PRACH, and may receive uplink allocation because the repeated PUSCH transmission has a higher priority than the synchronization signal block.

In step 905, in a case where the UE is configured through higher layer signaling, DCI, scheduled uplink channels or signals do not overlap in the same symbol, the UE proceeds to step 906 and determines whether to transmit an uplink channel or signal configured or scheduled through higher layer signaling or DCI as a Priority Condition 1 (Prioritization Rule 1). In step 905, in a case where the UE is configured through higher layer signaling or DCI, scheduled uplink channels, or signals overlaps in the same symbol, the UE proceeds to step 907 and determines whether to transmit an uplink channel or signal configured or scheduled through higher layer signaling or DCI as a Priority Condition 2 (Prioritization Rule 2). The Priority Condition 1 will be described in detail in a first situation to be described later, and the Priority Condition 2 will be described in detail in a second situation to be described later.

In a case where the UE determines that the synchronization signal block has priority through Priority Condition 1 in step 906, the UE proceeds to step 903 and receives a synchronization signal block based on the received SIB information or cell-specific configuration information through higher layer signaling. In step 906, in a case where the UE determines that the uplink channel or signal has priority through Priority Condition 1, the UE proceeds to step 908 and transmits an uplink channel or signal configured or scheduled through higher layer signaling or DCI in the uplink. Whether to receive the synchronization signal block may be determined according to a partial synchronization signal block reception condition described in a another embodiment to be described later.

In a case where the UE determines that the synchronization signal block has priority through Priority Condition 2 in step 907, the UE proceeds to step 903 and receives a synchronization signal block based on the received SIB information or cell-specific configuration information through higher layer signaling. In step 907, in a case where the UE determines that the uplink channel or a signal has priority through Priority Condition 2, the UE proceeds to step 908 and transmits an uplink channel or signal configured or scheduled through higher layer signaling or DCI in the uplink. Whether to receive the synchronization signal block may be determined according to a partial synchronization signal block reception condition described in another embodiment to be described later.

Each step described in FIG. 9 does not necessarily have to be performed according to the described order, and the order in which each step is performed. may be changed or omitted.

A first situation having a first priority condition may be defined as when different channels or signals of an uplink do not overlap.

The first situation having the first priority condition will be described in detail. As described above, in a case where uplink channels or signals configured or scheduled by the UE through higher layer signaling or DCI, for example, uplink data channels, uplink control channels, random access channels, or SRSs do not overlap in the same symbol, the UE may determine whether to transmit the uplink channels or signals with the first priority condition. The first priority condition is performed according to the conditions described below.

In a case where the UE configures or receives higher layer signaling or 1-bit DCI indicating that an uplink channel or signal has a higher priority than a synchronization signal block (e.g., UL_priorityInXDD), the uplink channel or signal may have a higher priority than the synchronization signal block. In this case, UL_priorityInXDD may or may not be configured or received simultaneously with SSB_priorityInXDD. If the UE does not configure or does not receive UL_priorityInXDD, the following conditions are followed.

Condition 1-1) In a case where the UE transmits PRACH:
A case where PRACH configured by the UE through higher layer signaling or DCI and synchronization signal block configured based on SIB information received by the UE or cell-specific configuration information through higher layer signaling overlap in at least one symbol, and/or
a case where PRACH is triggered through higher layer signaling, for example, ra-OccasionList, csirs-ResourceList is provided, and PRACH is transmitted to the primary cell, the PRACH may have a higher priority than the synchronization signal block. In the case of transmitting the PRACH other than the above, the PRAM may have a lower priority than the synchronization signal block.

Condition 1-2) In a case where the UE transmits PUSCH
A case where PUSCH configured or scheduled by the UE through higher layer signaling or DCI and synchronization signal block configured based on SIB information received by the UE or cell-specific configuration information through higher layer signaling overlap in at least one symbol,
a case where the UE receives the PUSCH transmission configuration of configured grant type 1 or type 2 with higher layer signaling including configuredGrantConfig and uplink data in which transformPrecoder, msg3-transformPrecoder or msgA-TransformPrecoder is set to “enable” is scheduled, the PUSCH may have a higher priority than the synchronization signal block, and/or
a case where the UE has numberOfRepetitions greater than X or receives a pusch-aggregationFactor configuration, or a case where a PUSCH with repeated transmission is scheduled through higher layer signaling including a value in which repK is greater than X, the PUSCH may have a higher priority than the synchronization signal block. in this case, the arbitrary number X may be set by higher layer signaling, and if not set, the default value is equal to 1.
In the case of transmitting PUSCH other than the above cases, the PUSCH may have a lower priority than the synchronization signal block.

Condition 1-3) In a case where the UE transmits PUCCH:
In a case where PUCCH configured or scheduled by the UE through higher layer signaling or DCI and a synchronization signal block configured based on SIB information received by the UE or cell-specific configuration information through higher layer signaling overlap in at least one symbol,
in a case where the UE receives a configuration to include a scheduling request (SR) in PUCCH format 0 or PUCCH format 1 transmission with higher layer signaling including SchedulingRequestResourceConfig or schedulingRequestID-BFR-SCell, the PUCCH may have a higher priority than the synchronization signal block, and/or
in a case where the UE receives PUCCH format 1, 3 or 4 transmission configured for repeated transmission through higher layer signaling including nrofSlot of PUCCH-config IE, the PUCCH may have a higher priority than the synchronization signal block.
In the case of transmitting PUCCH other than the above cases, the PUCCH may have a lower priority than the synchronization signal block.

Condition 1-4) In a case where the UE transmits SRS:
In a case where SRS is configured or scheduled by the UE through higher layer signaling or DCI and a synchronization signal block configured based on

SIB information received by the UE or cell-specific configuration information through higher layer signaling overlap in at least one symbol, in a case where the SRS transmission configured with the higher layer signaling including repetitionFactor by the UE is scheduled, the SRS may have a higher priority than the synchronization signal block, and/or
in a case where the UE has a resourceType of “periodic” and an SRS transmission configured with higher layer signaling including srs-ResourceConfigCLI for SRS-RSRP measurement for CLI is scheduled, the SRS may have a higher priority than the synchronization signal block.
In case of transmitting SRS other than the above cases, the SRS may have a lower priority than the synchronization signal block.

Here, the cases described in each of the above conditions satisfy mutually independent relationships. On the other hand, according to the partial synchronization signal block reception method to be described later, a case where some uplink symbols cannot be transmitted may occur.

A second situation with a second priority may defined as when different channels or signals of an uplink overlap.

The second situation with the second priority will be described in detail. As described above, in a case where uplink channels or signals configured or scheduled by the UE through higher layer signaling or DCI, for example, uplink data channels, uplink control channels, random access channels, or sounding reference signals overlap in the same symbol, the UE may determine whether to transmit the uplink channels or signals with the second priority.

In a case where the UE configures or receives higher layer signaling or 1-bit DCI indicating that an uplink channel or signal has a higher priority than a synchronization signal block (e.g., UL_priorityInXDD), the uplink channel or signal may have a higher priority than the synchronization signal block. UL_priorityInXDD may or may not be configured or received simultaneously with SSB_priorityInXDD. In a case where the UE does not configure or does not receive UL_priorityInXDD, the following conditions, described below may be followed.

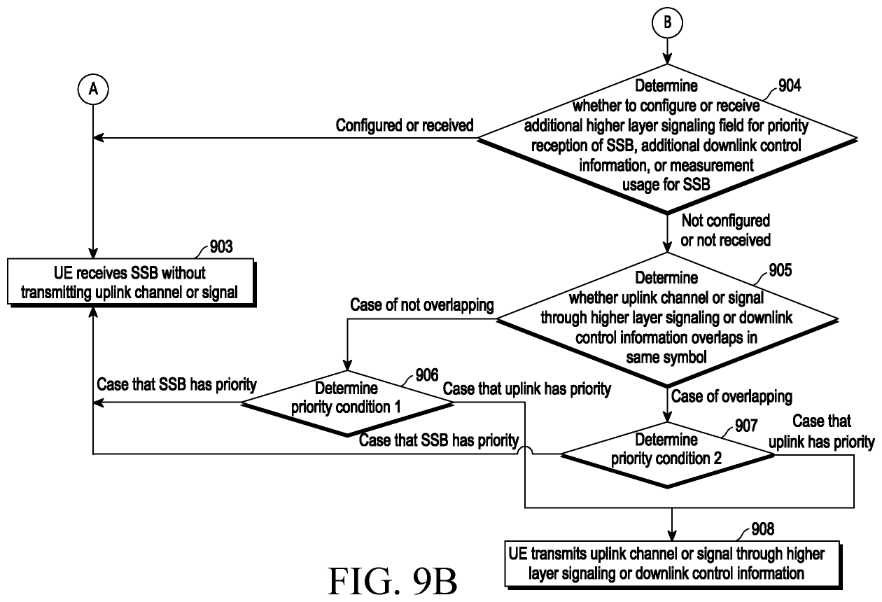

FIG. 10 is a diagram illustrating a method for a UE to determine whether to transmit an uplink channel and a signal with a second priority, according to an embodiment.

Referring to FIG. 10, in a case where an uplink channel or signal through higher layer signaling or DCI overlaps in the same symbol in step 1000, the UE proceeds to step 1001 and determines whether the uplink channels or signals overlapping in at least one symbol correspond to the case of the first priority condition. In this case, cases corresponding to the first priority condition may include the following conditions:
A case where PRACH is triggered through higher layer signaling, for example, ra-OccasionList, csirs-ResourceList is provided, and PRACH is transmitted to the primary cell.
A case where the UE receives the PUSCH transmission configuration of configured grant type 1 or type 2 with higher layer signaling including configuredGrantConfig and uplink data in which transformPrecoder, msg3-transformPrecoder or msgA-TransformPrecoder is set to “enable” is scheduled.
A case where the UE has numberOfRepetitions greater than X or receives a pusch-aggregationFactor configuration, or a case where a PUSCH with repeated transmission is scheduled through higher layer signaling including a value in which repK is greater than X (the arbitrary number X can be set by higher layer signaling, and when it is not set, the default value of X is equal to 1).
A case where the UE receives a configuration to include an SR in PUCCH format 0 or PUCCH format 1 transmission with higher layer signaling including SchedulingRequestResourceConfig or schedulingRequestID-BFR-SCell.
A case where the UE receives PUCCH format 1, 3 or 4 transmission configured for repeated transmission through higher layer signaling including nrofSlot of PUCCH-config IE.
A case where the SRS transmission configured with the higher layer signaling including repetitionFactor by the UE is scheduled.
A case where the UE has a resourceType of “periodic” and an SRS transmission configured with higher layer signaling including srs-ResourceConfigCLI for SRS-RSRP measurement for CLI is scheduled.

If not corresponding to the above-mentioned first priority condition case in step 1001, the UE proceeds to step 1002 and receives the synchronization signal block transmitted by the BS based on the received SIB information or cell-specific configuration information through higher layer signaling. If corresponding to the above-mentioned first priority condition case in step 1001, the UE proceeds to step 1003 and determines an uplink channel or signal to be transmitted according to the uplink priority rule of the current TDD operation standard (e.g., Rel-15/16). In step 1003, when the uplink channel or signal having the highest priority is determined and the corresponding uplink channel or signal is configured or indicated through higher layer signaling or downlink control information, the UE transmits the corresponding uplink channel or signal.

On the other hand, depending on the partial synchronization signal block reception method described in to be described later, a case may occur in which some uplink symbols may not be transmitted.

According to an embodiment, a synchronization signal block compensation method when the UE does not receive the synchronization signal block under a specific condition is described, below.

As described above, in a case where the UE prioritizes transmission of an uplink channel or signal through higher layer signaling or DCI, the UE may transmit an uplink channel or signal without receiving a synchronization signal block. In this case, in a case where the UE does not receive the synchronization signal block, link quality may be deteriorated due to omission of change of main system information or time-frequency synchronization misalignment. Accordingly, in another embodiment of the disclosure, a synchronization signal block compensation method for preventing or alleviating the problems in the following first or second situations will be described.

First situation: When all synchronization signal block burst sets are not received.

In the first situation, it is assumed that all synchronization signal block burst sets are not received. Here, the synchronization signal block burst set means a set including a plurality of synchronization signal blocks. In the first situation, compensation methods for the synchronization signal block signal will be described in detail below in Method 1-1, Method 1-2, Method 1-3, and. Method 1-4.

Method 1-1:

In a case where the synchronization signal block burst set is not received in the first situation, the UE may receive the synchronization signal block located in the return period based on the received SIB information or cell-specific configuration information through higher layer signaling. That is, the UE may not prioritize uplink channel or signal transmission twice in succession over the synchronization signal block. in addition, in a case where the UE receives the synchronization signal block located in the return period, higher layer signaling or DC1 including SSB_priorityInXDD may be configured or received.

Method 1-2:

In a case where the synchronization signal block burst set is not received in the first situation, the UE may receive a set period smaller than the existing period through higher layer signaling including the ssb-periodicityServingCell. As an example, in a case where the period is 20 ms, if the UE does not receive the synchronization signal block burst set, thereafter, a period of 10 ms may be set.

Method 1-3:

In a case where the synchronization signal block burst set is not received in the first situation, the UE may receive (or be configured to receive) a synchronization signal block having a UE-specific offset through UE-specific higher layer signaling or DCI. In a case where reception of the above-described synchronization signal block is not configured or is not received, the UE may expect to receive the synchronization signal block after N symbols based on the symbol at which transmission of the uplink channel or signal is terminated. In a case where the UE receives the synchronization signal block, BWP switching may be configured or instructed.

Method 1-4:

In a case where the synchronization signal block burst set is not received in the first situation, when the UE receives the UE-specific higher layer signaling NZP-CSI-RS-ResourceSet in which trs-Info is configured and the resourceType is set to “aperiodic”, aperiodic CSI-RS tracking reference signal (TRS) for time-frequency tracking may be scheduled through DCI. Methods 1-4 may be used only for the purpose of preventing link quality degradation by being QCLed with the synchronization signal block not received by the TRS and time-frequency synchronization misalignment.

Second situation: When a partial synchronization signal block included in the synchronization signal block burst set is received.

According to an embodiment of the disclosure, a second situation assumes that a synchronization signal block burst set is partially received. In this case, partially receiving the synchronization signal block burst set means receiving only a part of the plurality of synchronization signal blocks. For example, if 8 synchronization signal blocks are configured, reception of only 4 blocks among them may be said to be partially received. However, the partial reception does not include reception of only some symbols among the four symbols constituting the synchronization signal block. In the second situation, partial reception methods for the synchronization signal block signal will be described in detail below

In order to apply the method of partially receiving the synchronization signal block burst set, the following conditions must be satisfied:

The center frequency of the downlink and uplink BWP should be the same. For example, it may be applied to Case 1-1 or Case 2 of FIG. 8. When the center frequencies of BWPs are not the same, in a case where there is a switch from downlink to uplink within one slot, a delay time may occur because BWP switching is performed.
In a case where the UE performs downlink and uplink switching in one slot, at least Y symbol switching time is required. An arbitrary value Y may be set with higher layer signaling or DCI.
Available only within flexible symbols.

The above conditions are not necessarily all satisfied, and each condition may be changed or omitted.

Method 2-1:

In a case where the above-mentioned condition(s) is(are) satisfied in The second situation, the UE may receive synchronization signal blocks in which no symbols overlap with the symbols of an uplink channel or signal scheduled through higher layer signaling or DCI among synchronization signal blocks included in the synchronization signal block burst set.

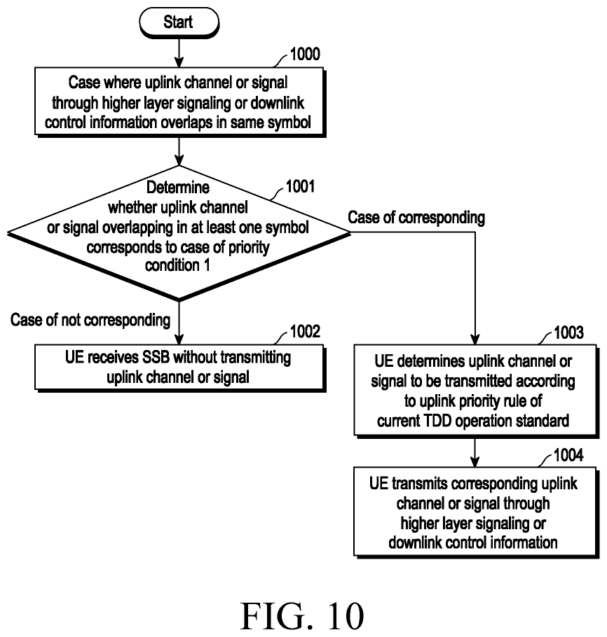

FIG. 11 is a diagram illustrating a method in which a UE partially receives a synchronization signal block in a second situation, according to an embodiment.

Referring to FIG. 11, the UE may receive configuration of the synchronization signal block corresponding to the Case C 603 pattern of FIG. 6 in the downlink 1100 in the XDD system, and may receive configuration of the synchronization signal block #0 1110 and the synchronization signal block #1 1111 in the slot #0 1102 and the synchronization signal block #2 1112 and the synchronization signal block #3 1113 in the slot #1 1103. On the other hand, the UE may receive configuration of the first repeated transmission 1120 and the second repeated transmission 1121 of the uplink data in the slot #0 1102. In this case, if the above-described Method 2-1 is applied, the UE does not receive the synchronization signal blocks 1110 and 1112 overlapping in the symbol in which the uplink data is scheduled, but receives the synchronization signal blocks 1111 and 1113 that do not overlap. The UE uses 0, 1, 2, 3, 4, 5, and 6 symbols as uplink symbols and 8, 9, 10, and 11 symbols as downlink symbols. In this case, because the above-mentioned condition(s) is(are) satisfied, the center frequency is the same, so even if the downlink BWP size is bigger than the uplink BWP size, BWP switching is not required.

Method 2-2:

In case the condition(s) described above in the second situation is(are) satisfied, the UE may receive only one synchronization signal block having an index associated with an uplink channel or a signal and used as a QCL source among synchronization signal blocks included in the synchronization signal block burst set. The synchronization signal block index may be configured by higher layer signaling including at least one of ssb-Index, ssb-IndexServing, or ssb-IndexNcell.

For example, in FIG. 11, when the UE receives index 2 configured in higher layer signaling including at least one of ssb-Index, ssb-IndexServing, or ssb-IndexNcell, and at this case, if the above-described Method 2-2 is applied, the UE does not receive synchronization signal blocks 1110, 1111, and 1113 of other indexes except for synchronization signal block #2 1112 having an index of 2. In other words, although the UE transmits the first repeated transmission 1120 of uplink data in slot #0 1102, in the second repeated transmission 1121 of uplink data in slot #1 1103, the UE cannot transmit a symbol overlapping the synchronization signal block #2 1112 having an index of 2. Uplink data symbols that cannot be transmitted because they overlap the synchronization signal block are dropped according to the current TDD operation standard (e.g., Rel-15/16). However, if at least one symbol is not transmitted from an uplink channel or signal scheduled or configured in a slot including a synchronization signal block burst set by Method 2-2, Method 2-2 cannot be applied.

Method 2-3:

In case the condition(s) described above in the second situation is(are) satisfied, the UE may receive the synchronization signal blocks having the largest index of Z among the reference signal received power (RSRP) measurement values of the previously measured synchronization signal block signal among the synchronization signal blocks included in the synchronization signal block burst set. An arbitrary value Z may be set through higher layer signaling.

In a case where the UE applies the Method 2-3, the UE may receive the synchronization signal blocks having the index corresponding to the largest Z among the RSRP measurement values of the previously measured synchronization signal block signal. In this case, if the Z value is set to 3 as higher layer signaling, and the corresponding synchronization signal block index is 1, 2, and 3, the UE does not receive synchronization signal blocks #0 1110 of other indexes except for the synchronization signal blocks 111, 1112, and 1113 having indices 1, 2, and 3. In other words, although the UE transmits the first repeated transmission 1120 of uplink data in slot #0 1102, in the second repeated transmission 1121 of uplink data in slot #1 1103, the UE cannot transmit a symbol overlapping the synchronization signal block #2 1112 having an index of 2. Uplink data symbols that cannot be transmitted because they overlap the synchronization signal block are dropped according to the current TDD operation standard (e.g., Rel-15/16). However, if at least one symbol is not transmitted from an uplink channel or signal scheduled or configured in a slot including a synchronization signal block burst set by Method 2-3, Method 2-3 cannot be applied.

A Type 1 HARQ-ACK codebook generation method in the XDD system will now be described.

A method of generating a Type 1 HARQ-ACK codebook in an XDD system will be described in detail.

According to an embodiment, in an XDD system, because different dual communication directions can be supported within the same time resource, that is, uplink and downlink can be used at different frequency resource positions within the same time resource, it is necessary to consider a specific time resource in which uplink transmission and downlink reception occur at different frequency resource positions when generating a Type 1 HARQ-ACK codebook that may be generated in consideration of the position of a time resource (e.g., a symbol and/or a slot) configured with downlink for which a downlink data channel (PDSCR) may be transmitted.

First, a method for generating a Type 1 HARQ-ACK codebook will be described in detail. When the PDSCH is scheduled based on DCI information of the PDCCH, slot information to which a PDSCH is transmitted and to which corresponding. HARQ-ACK feedback is mapped, and mapping information of PUCCH, which is an uplink control channel delivering HARQ-ACK feedback information, are delivered through the PDCCH. Specifically, the slot interval between the downlink data PDSCH and the corresponding HARQ-ACK feedback is indicated through the PDSCH-to-HARQ feedback timing indicator, one of eight feedback timing offsets set through higher layer signaling (e.g., RRC signaling) may be indicated. In addition, in order to deliver PUCCH resources including the type of PUCCH to which the HARQ-ACK feedback information will be mapped, the position of the start symbol, and/or the number of mapping symbols, one of eight resources configured with higher layer signaling may be indicated through a PUCCH resource indicator. The UE may collect and transmit the HARQ-ACK feedback bits to transmit the HARQ-ACK information to the BS, and hereinafter, the collected HARQ-ACK feedback bits may be referred to by mixing with the HARQ-ACK codebook.

The BS may configure the Type-1 HARQ-ACK codebook to the UE to transmit HARQ-ACK feedback bits corresponding to the PDSCH that may be transmitted at a slot position of a predetermined timing regardless of whether or not the actual PDSCH is transmitted. Alternatively, the BS may configure to the UE a Type-2 HARQ-ACK codebook that manages and transmits HARQ-ACK feedback bits corresponding to the actually transmitted PDSCH through a counter downlink assignment index (DAI) or total DAI.

In a case where the UE receives the Type-1 HARQ-ACK codebook configured, the UE may determine the feedback bit to be transmitted through a table including information on a slot to which the PDSCH is mapped, a start symbol, the number of symbols, and/or length information, and K1 (governing time domain slot and symbol level resource allocation) candidate values that are HARQ-ACK feedback timing information for the PDSCH. A table including the start symbol, number of symbols, and/or length information of the PDSCH may be configured with higher layer signaling or may be configured as a default table. In addition, the K1 candidate values may be determined as default values, for example {1,2,3,4,5,6,7,8}, or determined through higher layer signaling. The slot to which the PDSCH is mapped may be identified through the K1 value in a case where the PDSCH is transmitted from a single slot, and in a case where the PDSCH is repeatedly transmitted (slot aggregation) in a plurality of slots, the K1 value and a higher layer parameter indicating the number of repeated transmissions, for example, the pdsch-AggregationFactor value set in the PDSCH-Config IE in the active BWP may be identified. In a case where the PDSCH is repeatedly transmitted from a plurality of slots, the K1 value is indicated on the basis of the last slot during repeated PDSCH transmission, and the slot to which the PDSCH is mapped is regarded as the last slot repeatedly transmitted, that is, the pdsch-AggregationFactor-th slot from the repeated transmission start slot.

If the set of PDSCH reception candidate cases in the serving cell c is M_{A,c}, M_{A,c} may be determined by the following [pseudo-code 1] steps.

[Start of pseudo-code 1]
Step 1: Initialize j to 0, M_{A,c} to an empty set, and k, which is a HARQ-ACK transmission timing index, to 0.
Step 2: Set R as a set of each row in the table including the slot to which the PDSCH is mapped, the start symbol, the number of symbols and/or the length information. if the symbol to which the PDSCH indicated by each row of R is mapped is set as an uplink symbol according to the higher layer signaling configuration, the corresponding row is deleted from R.
Step 3-1: In a case where the UE may receive one unicast PDSCH in one slot and R is not an empty set, k is added to the set M_{A,c}.
Step 3-2: In a case where the UE may receive a plurality of PDSCHs in one slot, increases j by 1 as much as the number corresponding to the maximum number of PDSCHs that may be allocated to different symbols in R and adds them to M_{A,c}.
Step 4: Restart from step 2 by incrementing k by 1.

[End of pseudo-code 1]

HARQ-ACK feedback bits may be determined in the following steps of [pseudo-code 2] for M_{A,c} determined by [pseudo-code 1] above,

[Start of pseudo-code 2]
Step 1: initialize HARQ-ACK reception occasion index m to 0 and HARQ-ACK feedback bit index j to 0.
Step 2-1: In a case where the UE is instructed to receive up to two codewords through one PDSCH without being instructed for HARQ-ACK bundling for codewords through higher layer signaling, and without being instructed to transmit code block group (CBG) of PDSCH, increase j by 1 and configure the HARQ-ACK feedback bit for each codeword.
Step 2-2: in a case where the UE is instructed to bundle HARQ-ACK for codewords through higher layer signaling and is instructed to receive up to two codewords through one PDSCH, configure the HARQ-ACK feedback bit for each codeword as one HARQ-ACK feedback bit through binary AND operation.
Step 2-3: In a case where the UE is instructed to transmit the CBG of the PDSCH through higher layer signaling and is not instructed to receive up to two codewords through one PDSCH, increase j by 1 and configure HARQ-ACK feedback bits as many as the number of CBGs for one codeword.
Step 2-4: In a case where the UE is instructed to transmit CBG of the PDSCH through higher layer signaling and is instructed to receive up to two codewords through one PDSCH, increase j by 1 and configure HARQ-ACK feedback bits as many as the number of CBGs for each codeword.
Step 2-5: In a case where the UE is not instructed to transmit the CBG of the PDSCH through higher layer signaling and is not instructed to receive up to two codewords through one PDSCH, configure HARQ-ACK feedback bits for one codeword.
Step 3: Start again from step 2-1 by increasing m by 1.

[end of pseudo-code 2]

As described above, in a case where the UE generates the Type 1 HARQ-ACK codebook, as in step 2 of [pseudo-code 1], if the symbol to which the PDSCH indicated by each row of R is mapped is configured as an uplink symbol according to the higher layer signaling configuration, the UE may delete the corresponding row from R to exclude it from generating the HARQ-ACK codebook. This is a natural operation in a TDD system in which all frequency resources of a specific time resource (e.g., symbols and/or slots) may he uplink or downlink, but, as described above, in the case of an XDD system in which uplink and downlink operations may occur simultaneously in different frequency resource positions within the same time resource, the UE may determine whether it is a symbol to be excluded in step 2 of [pseudo-code 1] or whether it is a symbol to be additionally considered in step 2 of [pseudo-code 1], and perform Type 1 HARQ-ACK codebook generation. A time resource in which uplink and downlink operations may occur simultaneously in the different frequency resource positions may exist within one BWP configured for a specific UE, and may exist between a downlink BWP configured for a first UE and an uplink BWP configured for a second UE that do not overlap each other on frequency resources.

According to an embodiment, in the XDD system, methods of generating a Type 1 HARQ-ACK codebook by determining whether a symbol to be excluded in step 2 of [pseudo-code 1] or a symbol to be additionally considered in step 2 of [pseudo-code 1] will be described in detail below.

Method 3-1:

As in step 2 of the above-mentioned [pseudo-code 1], if at least some frequency resources are configured as uplink resources in the symbol to which the PDSCH indicated by each row of R is mapped according to the higher layer signaling configuration, the UE may delete the corresponding row from R to exclude the corresponding row from generating the HARQ-ACK codebook. In this case, although some remaining frequency resources are configured as downlink resources in the corresponding symbol, and downlink transmission (e.g., PDSCH) is possible in the frequency resources, the time resource allocation indication including the corresponding symbol may be excluded from the Type 1 HARQ-ACK codebook generation. This may be understood as a direction of excluding downlink signal transmission in the above symbol in order to preferentially consider uplink signals for the purpose of improving coverage for uplink transmission in the XDD system. Accordingly, PDSCH scheduling may be limited, and the size of the codebook may be reduced when generating the Type 1 HARQ-ACK codebook, but it is possible to prevent deterioration of the decoding performance of the PDSCH due to interference caused by uplink transmission. In addition, due to the Method 3-1, a specific symbol in which at least some frequency resources are configured as uplink resources in the XDD system may be regarded as uplink symbols in the TDD system. That is, only time resources (e.g., symbols and/or slots) in which all frequency resources are configured as downlink resources may be regarded as downlink symbols, and all other symbols may be regarded as uplink symbols. In addition, through the Method 3-1, in a case where at least some frequency resources of a specific time resource are configured with uplink, the UE may not expect that the PDSCH is scheduled to the corresponding time resource, or in a case where at least one uplink channel (e.g., PRACH, PUCCH, PUSCH, or SRS) is transmitted through a frequency resource configured with uplink in the corresponding time resource, the UE may ignore the PDSCH reception that may be transmitted through a frequency resource configured with downlink within the corresponding time resource.

Method 3-2:

As in step 2 of the above-mentioned [pseudo-code 1], for the case in which all frequency resources are configured as uplink resources in the symbol to which the PDSCH indicated by each row of R is mapped according to the higher layer signaling configuration, the UE may delete the corresponding row from R to exclude the corresponding row from generating the HARQ-ACK codebook. In this case, unlike Method 3-1, because all frequency resources are excluded from the generation of the Type 1 HARQ-ACK codebook only when the uplink resources are configured, in a case where at least some frequency resources are configured as downlink resources, the UE may include them in HARQ-ACK codebook generation. This may increase flexibility for PDSCH scheduling, and may have a feature that the size of the codebook may be relatively increased compared to Method 3-1 when generating the Type 1 HARQ-ACK codebook. In addition, in a case where at least some frequency resources are configured as downlink resources, because the frequency resources are included in Type 1 HARQ-ACK codebook generation, if the UE succeeds in decoding after receiving the PDSCH scheduled in the frequency resource configured as the downlink resource within the same time resource despite the interference of uplink transmission although any uplink transmission is performed on some of the remaining frequency resources set as uplink resources, the corresponding method may not have a specific priority between uplink or downlink signal transmission within the same time resource because information in the Type 1 HARQ-ACK codebook corresponding to the decoding success may be generated as ACK.

Method 3-3:

Similar to the Method 3-2 described above, as in step 2 of the above-mentioned [pseudo-code 1], only the case that all frequency resources are configured as uplink resources in the symbol to which the PDSCH indicated by each row of R is mapped according to the higher layer signaling configuration, the UE may delete the corresponding row from R to exclude the corresponding row from generating the HARQ-ACK codebook. However, as an additional constraint, there may be priorities between a channel that may be transmitted from some frequency resources configured with uplink in the corresponding time resource (e.g., symbol and/or slot) and PDSCH that may be transmitted from some remaining frequency resources configured with downlink. For example, at least one uplink channel or signal among PUCCH, PUSCH, PRACH, or SRS that may be transmitted from the corresponding uplink frequency resource may have a lower priority than a PDSCH that may be transmitted from a downlink frequency resource within the same time resource. As an example, in a case where the UE is configured with downlink for some frequency resources within a specific time resource and receives a PDSCH scheduled in the corresponding downlink frequency resource, the UE may not be able to transmit PUSCH in the corresponding uplink frequency resource even if the UE is configured with uplink for some remaining frequency resources. That is, the reception of the PDSCH may have priority over transmission of the PUSCH from the perspective of the UE.

Method 3-4:

Similar to the Method 3-2 described above, as in step 2 of the above-mentioned [pseudo-code 1], in a case where all frequency resources are configured as uplink resources in the symbol to which the PDSCH indicated by each row of R is mapped according to the higher layer signaling configuration, or in a case where at least some frequency resources are configured as uplink resources and a specific uplink signal is transmitted from the corresponding uplink resources, the UE may delete the corresponding row from R to exclude the corresponding row from generating the HARQ-ACK codebook. This may be regarded as a method to be reflected when generating the type 1 HARQ-ACK codebook considering the priority between a PDSCH that may be transmitted from a frequency resource configured with downlink within the corresponding time resource (e.g., symbols and/or slots) and a specific uplink signal (e.g., at least one of PUCCH, PUSCH, PRACH, or SRS) that may be transmitted from a frequency resource configured with uplink in the corresponding time resource, and if an uplink signal that may have a higher priority than the PDSCH is transmitted from the corresponding time resource, the PDSCH will not be transmitted from the corresponding time resource, so the PDSCH may be excluded when generating the Type 1 HARQ-ACK codebook. In the case of considering such priorities, the priority with the PDSCH may be determined by considering the transmission type (e.g., periodic, semi-permanent, or aperiodic transmission) in the time resource of the uplink transmission signal, whether single repeat transmission, whether UCI is included in the case of PUSCH, and which UCI is included if UCI is included. For example, a PUSCH that does not include a single transmitted UCI may have a lower priority than a PDSCH, and a repeatedly transmitted PUCCH may have a higher priority than a PDSCH. In addition, in the above-mentioned priority determination, because the Type 1 HARQ-ACK codebook is semi-statically generated for all possible time resource candidates in which the PDSCH may be scheduled based on time resource allocation information configured through higher layer signaling, PUCCH, PUSCH, or SRS that may be dynamically scheduled (i.e., may be indicated through DCI) may be excluded from priority consideration.

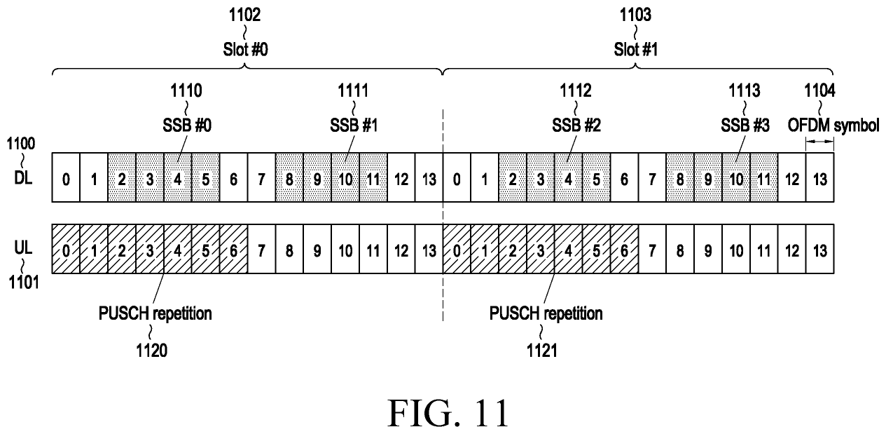

FIG. 12 is a block diagram illustrating a structure of a UE in a wireless communication system, according to an embodiment.

Referring to FIG. 12, the UE 1200 includes a UE receiver 1205, a UE transmitter 1215, and a UE processor (a controller) 1210.

The UE receiver 1205 and the UE transmitter 1215 may he referred to as a transceiver together. According to the communication method of the UE described above, the UE receiver 1205, the UE transmitter 1215, and the UE processor 1210 of the UE 1200 may operate. However, the components of the UE 1200 are not limited to the above-described example. For example, the UE may include more components a memory) or fewer components than the above-described components, In addition, the UE receiver 1205, the UE transmitter 1215, and the UE processor 1210 may be implemented in the form of a single chip.

The UE receiver 1205 and the UE transmitter 1215 (or transceiver) may transmit and receive signals to and from the BS. Here, the signal may include control information and data. To this end, the transceiver may include a radio frequency (RF) transmitter up-converting and amplifying a frequency of a transmitted signal, and an RF receiver low-noise amplifying and down-converting a received signal. However, this is only an embodiment of the transceiver, and components of the transceiver are not limited to the RF transmitter and the RF receiver.

In addition, the transceiver may receive a signal through a wireless channel, output the signal to the UE processor 1210, and transmit a signal output from the UE processor 1210 through a wireless channel.

The memory may store programs and data necessary for the operation of the UE 1200. In addition, the memory may store control information or data included in a signal obtained from the UE. The memory may consist of a storage medium such as a read only memory (ROM), a random access memory (RAM), a hard disk, a compact disc (CD)-ROM, and a digital versatile disc (DVD) or a combination of storage media,

The UE processor 1210 may control a series of processes so that the UE may operate according to the above-described embodiments of the disclosure. The UE processor 1210 may be implemented as a controller or one or more processors.

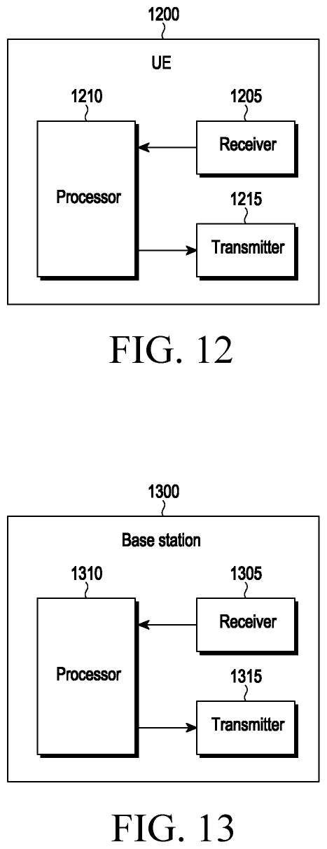

FIG. 13 is a diagram illustrating a structure of a BS in a wireless communication system, according to an embodiment.

Referring to FIG. 13, the BS 1300 includes a BS receiver 1305, a BS transmitter 1315, and a BS processor (a controller) 1310.

The BS receiver 1305 and the BS transmitter 1315 may be referred to as a transceiver together. According to the communication method of the BS described above, the BS receiver 1305, the BS transmitter 1315, and the BS processor 1310 of the BS 1300 may operate. However, the components of the BS 1300 are not limited to the above-described example. For example, the BS 1300 may include more components (e.g., a memory) or fewer components than the above-described components. in addition, the BS receiver 1305, the BS transmitter 1315, and the BS processor 1310 may be implemented in the form of a single chip.

The BS receiver 1305 and the BS transmitter 1315 (or transceiver) may transmit and receive signals to and from the UE. Here, the signal may include control information and data. To this end, the transceiver may include an RF transmitter up-converting and amplifying a frequency of a transmitted signal, and an RF receiver low-noise amplifying and down-converting a. received signal. However, this is only an embodiment of the transceiver, and components of the transceiver are not limited to the RF transmitter and the RF receiver.

In addition, the transceiver may receive a signal through a wireless channel, output the signal to the BS processor 1310, and transmit a signal output from the BS processor 1310 through a wireless channel.

The memory may store programs and data necessary for the operation of the BS 1300. In addition, the memory may store control information or data included in a signal obtained from the BS. The memory may consist of a storage medium such as ROM, RAM, hard disk, CD-ROM, and DVD or a combination of storage media.

The BS processor 1310 may control a series of processes so that the BS may operate according to the above-described embodiments of the disclosure. The BS processor 1310 may be implemented as a controller or one or more processors.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Further, in the methods of the disclosure, some or all of the contents included in each embodiment may be combined without departing from the essential spirit and scope of the disclosure.

Further, it is possible to implement methods using separate tables or information in which at least one element included in the tables in the disclosure is used.

According to the disclosure, when a UE in a wireless communication system meets a specific condition, it is possible to increase uplink coverage and provide a low-latency communication service.

The embodiments of the disclosure described and shown in the specification and the drawings are merely specific examples that have been presented to easily explain the technical contents of the disclosure and help understanding of the disclosure, and are not intended to limit the scope of the disclosure. That is, it will he apparent to those skilled in the art that other variants based on the technical idea of the disclosure may be implemented. Further, the above respective embodiments may be employed in combination, a.s necessary.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method of a. user equipment (UE) comprising:
identifying a position of a first symbol in which a synchronization signal block is transmitted through cell specific configuration information based on at least one of system information block (SIB) information or higher layer signaling;
determining whether a second symbol of an uplink channel configured based on at least one of the higher layer signaling or downlink control information overlaps with the first symbol in which the synchronization signal block is transmitted;
transmitting the synchronization signal block without transmitting the uplink channel in response to the determination that the second symbol of the uplink channel does not overlap with the first symbol in which the synchronization signal block is transmitted; and
determining whether to transmit the uplink channel according to a predetermined condition in response to the determination that the second symbol of the uplink channel overlaps with the first symbol in which the synchronization signal block is transmitted.

2. The method of claim 1, wherein determining whether to transmit the uplink channel according to the predetermined condition in response to the determination that the second symbol of the uplink channel overlaps with the first symbol in which the synchronization signal block is transmitted further comprises determining whether a cross division duplex (XDD) indicator is configured or received.

3. The method of claim 2, further comprising transmitting an uplink signal to a base station based on a result of determining whether the XDD indicator is configured or received.

4. The method of claim 2, further comprising determining whether to schedule an uplink signal through the downlink control information if the XDD indicator is determined to be configured or received.

5. The method of claim 2, further comprising:
determining whether to schedule an uplink signal based on a coverage-related configuration if the XDD indicator is determined to be configured or received; and
transmitting the scheduled uplink signal if it is determined that the uplink signal is scheduled based on the coverage related information.

6. The method of claim 5, wherein the uplink signal is not transmitted without scheduling the uplink signal based on the coverage related information.

2. The method of claim 2, wherein the XDD indicator is configured using at least one of system information, the higher layer signaling, a medium access control control element (MAC CE), or the downlink control information.

8. The method of claim 2, further comprising, in a case where it is determined that the UE has configured or received the XDD indicator, determining whether to configure or receive an additional higher layer signaling field that configures or indicates priority reception of a synchronization signal block, an additional 1-bit downlink control information configuring or indicating priority reception of a synchronization signal block, or a measurement usage for the synchronization signal block.

9. The method of claim 8, further comprising, in a case where the UE has configured or received the additional higher layer signaling field, the additional 1-bit downlink control information, or the measurement usage for the synchronization signal block, receiving a synchronization signal block based on the SIB information or cell-specific configuration information through the higher layer signaling.

10. The method of claim 8, further comprising, in a case where the UE has not configured or received the additional higher layer signaling field, the additional 1-bit downlink control information, or the measurement usage for the synchronization signal block, determining whether uplink channels or signals configured or scheduled through the higher layer signaling or the downlink control information overlap in the same symbol.

11. A user equipment (UE) comprising:
a transceiver; and
a controller coupled with the transceiver and configured to:
identify a position of a first symbol in which a synchronization signal block is transmitted through cell specific configuration information based on at least one of system information block (SIB) information or higher layer signaling,
determine whether a second symbol of an uplink channel configured based on at least one of the higher layer signaling or downlink control information overlaps with the first symbol in which the synchronization signal block is transmitted,
transmit the synchronization signal block without transmitting the uplink channel in response to the determination that the second symbol of the uplink channel does not overlap with the first symbol in which the synchronization signal block is transmitted, and
determine whether to transmit the uplink channel according to a predetermined condition in response to the determination that the second symbol of the uplink channel overlaps with the first symbol in which the synchronization signal block is transmitted.

12. The UE of claim 11, wherein determining whether to transmit the uplink channel according to the predetermined condition in response to the determination that the second symbol of the uplink channel overlaps with the first symbol in which the synchronization signal block is transmitted further comprises determining whether a cross division duplex (XDD) indicator is configured or received.

13. The UE of claim 12, wherein the controller is further configured to transmit an uplink signal to a base station based on a result of determining whether the XDD indicator is configured or received.

14. The UE of claim 12, wherein the controller is further configured to determine whether to schedule an uplink signal through the downlink control information if the XDD indicator is determined to be configured or received.

15. The UE of claim 12, wherein the controller is further configured to:
determine whether to schedule an uplink signal based on a coverage-related configuration if the XDD indicator is determined to be configured or received; and
transmit the scheduled uplink signal if it is determined that the uplink signal is scheduled based on the coverage related information.

16. The UE of claim 15, wherein the uplink signal is not transmitted without scheduling the uplink signal based on the coverage related information.

17. The UL of claim 12, wherein the XDD indicator is configured using at least one of system information, the higher layer signaling, a medium access control control element (MAC CE), or the downlink control information.

18. The UE of claim 12, wherein the controller is further configured to, in a case where it is determined that the UE has configured or received the XDD indicator, determine whether to configure or receive an additional higher layer signaling field that configures or indicates priority reception of a synchronization signal block, an additional 1-bit downlink control information configuring or indicating priority reception of a synchronization signal block, or a measurement usage for the synchronization signal block.

19. The UE of claim 18, wherein the controller is further configured to, in a case where the UE has configured or received the additional higher layer signaling field, the additional 1-bit downlink control information, or the measurement usage for the synchronization signal block, receive a synchronization signal block based on the SIB information or cell-specific configuration information through the higher layer signaling.

20. The UE of claim 18, wherein the controller is further configured to, in a case where the UE has not configured or received the additional higher layer signaling field, the additional 1-bit downlink control information, or the measurement usage for the synchronization signal block, determine whether uplink channels or signals configured or scheduled through the higher layer signaling or the downlink control information overlap in the same symbol.
